(19) United States
(12) Patent Application Publication
(10) Pub. No.: US 2024/0076562 A1
(43) Pub. Date: Mar. 7, 2024

(54) CONVERTING BIOMASS TO DIESEL

(71) Applicant: Abundia Biomass-to-Liquids Limited, Redcar (GB)

(72) Inventor: Martin Atkins, Redcar (GB)

(21) Appl. No.: 18/270,568

(22) PCT Filed: Dec. 31, 2021
(86) PCT No.: PCT/GB2021/053450

§ 371 Date: Jun. 30, 2023

(30) Foreign Application Priority Data
Dec. 31, 2020 (GB) 2020913.6

(51) Int. Cl. C10G 65/12; B01D 3/14; B01J 23/80; C01B 3/12; C01B 32/50; C10B 53/02; C10B 57/16

(52) U.S. Cl. CPC C10G 65/12; B01D 3/14; B01J 23/80; C01B 3/12; C01B 32/50; C10B 53/02; C10B 57/16; C10G 2300/1014; C10G 2300/4006; C10G 2300/4012; C10G 2400/02; C10G 2400/04; C10G 2400/08

(57) ABSTRACT

The present invention relates to a process and system for forming a bio-derived diesel fuel from a biomass material, and the bio-derived diesel fuel formed therefrom. The present invention also relates to a process and system for forming a bio-derived diesel fuel from a bio-derived hydrocarbon feedstock, and the bio-derived diesel fuel formed therefrom.

### FIELD OF INVENTION

The present invention relates to a process and system for forming a bio-derived diesel fuel from a biomass material, and the bio-derived diesel fuel formed therefrom. The present invention also relates to a process and system for forming a bio-derived diesel fuel from a bio-derived hydrocarbon feedstock, and the bio-derived diesel fuel formed therefrom.

### BACKGROUND

Demand for energy has increased over the years due to greater dependence on technology both in a personal and commercial capacity, expanding global population and the required technological progress made in developing countries. Energy resources have traditionally been derived primarily from fossil fuels however, as supply of such resources declines, a greater significance is placed on research looking at alternative methods of providing energy. Further, increased awareness of the environmental impact of burning fossil fuels and commitments to reducing the emission of greenhouse gases has significantly increased the demand for greener energy resources.

Bio-fuels are considered to be a promising, more environmentally-friendly alternative to fossil fuels, in particular, diesel, naphtha, gasoline and jet fuel. Presently, such materials are only partly replaced with bio-derived fuels through blending. Due to the costs associated with the formation of some biofuels it is not yet commercially viable to manufacture fuels entirely derived from biomass materials. Even where bio-derived fuels are combined with fossil fuels, difficulties in blending some bio-derived fuels can lead to extended processing times and higher costs.

The term biomass is commonly used with respect to materials formed from plant-based sources, such as corn, soy beans, flaxseed, rapeseed, sugar cane, and palm oil, however this term encompasses materials formed from any recently living organisms, or their metabolic by-products. Biomass materials comprise lower amounts of nitrogen and sulphur compared to fossil fuels and produces no net increase in atmospheric CO₂ levels, and so the formation of an economically viable bio-derived fuel would be environmentally beneficial.

High quality fossil fuels, such as diesel and jet fuel are formed by refining crude oils. The diesel fuels produced mainly comprise saturated paraffins, including n-, iso- and cycloparaffins, but also comprise aromatic hydrocarbons, such as naphthalenes and alkylbenzene. Diesel fuels typically undergo additional refining/upgrading processes, including hydro-treating processes to reduce the amount of sulphur present, catalytic cracking and/or hydrocracking to reduce the presence of larger hydrocarbon compounds, and optionally blending with other streams, in order to produce a fuel meeting all of the requisite chemical, physical, economic and inventory requirements of a diesel fuel product.

Fossil fuel-based diesels are formed from a complex mixture of hydrocarbon compounds, wherein the majority of hydrocarbon compounds comprise a carbon number of between 10 and 22.

For a bio-fuel to be considered fungible to crude oil-based diesel fuels, it must also meet the standardised chemical and physical properties of these materials, as defined in “Automotive fuels—Diesel—Requirements and test methods” European Standard EN 590:2009 and “Standard Specification for Diesel Fuel Oils” ASTM D975. These standards define the specification properties required of a diesel fuel in Europe, for example the standard required of a Euro 6 grade diesel oil is shown in Table 1.

TABLE 1

| | | Limits | | |
|---|---|---|---|---|
| Property | Unit | Minimum | Maximum | Test Method |
| Cetane number | | 51.0 | | EN ISO 5165 |
| | | | | EN 15195 |
| Cetane index | | 46.0 | | EN ISO 4264 |
| Density at 15° C. | kg/m³ | 820.0 | 845.0 | EN ISO 3675 |
| | | | | EN ISO 12185 |
| Polycyclic aromatic | % (m/m) | | 11 | EN 12916 |
| Hydrocarbons | | | | |
| Sulfur content | mg/kg | | 10.0 | EN ISO 20846 |
| | | | | EN ISO 20884 |
| Flash point | ° C. | Above 55 | | EN ISO 2719 |
| Carbon residue | % (m/m) | | 0.33 | EN ISO 10370 |
| (on 10% distillation residue) | | | | |
| Ash content | % (m/m) | | 0.01 | EN ISO 6245 |
| Water content | mg/kg | | 200 | EN ISO 12937 |
| Total contamination | mg/kg | | 24 | EN 12662 |
| Copper strip corrosion | rating | Class 1 | | EN ISO 2160 |
| (3 h at 50° C.) | | | | |
| Fatty acid methyl ester | % (V/V) | | 7.0 | EN 14078 |
| (FAME) content | | | | |
| Oxidation stability | g/m³ | | 25 | EN ISO 12205 |
| | h | 20 | | EN 15751 |
| Lubricity, corrected wear scar | μm | | 460 | EN ISO 12156-1 |
| diameter (wsd 1, 4) at 60° C. | | | | |
| Viscosity at 40° C. | mm²/s | 2.00 | 4.50 | EN ISO 3104 |
| Distillation | | | | EN ISO 3405 |
| % (V/V) recovered at 250° C. | % (V/V) | | <65 | |
| % (V/V) recovered at 350° C. | % (V/V) | 85 | | |
| 95% (V/V) recovered at | ° C. | | 360 | |

Particularly important requirements of any diesel fuel (or hydrocarbon feedstock for use in forming a diesel fuel) are i) the amount of sulphur present, and ii) the freezing point of the material. Combustion of sulphur containing hydrocarbons leads to the formation of sulphur oxides. Sulphur oxides are considered to contribute to the formation of aerosol and particulate matter (soot) which can lead to reduced flow or blockages in filters and component parts of combustion engines. Furthermore, sulphur oxides are known to cause corrosion of turbine blades, and so high sulphur content in a fuel is highly undesirable. The European Standard EN590:2009 states that diesel fuels may contain at most 10 mg/kg of sulphur, however in the US up to 15 mg/kg of sulphur is considered acceptable.

An essential property of any alternative diesel fuel is the fluidity of the material at lower temperatures. The fluidity of fuels can be determined based on the cloud point and the pour point of the material. Diesel fuels contain paraffin wax which melts in the temperature range of between 40° C. and 80° C., thus at lower temperatures paraffin wax begins to solidify, forming paraffin wax crystals. The temperature at which wax begins to precipitate and the fuel becomes cloudy is referred to as the cloud point. As the temperature of the fuel is reduced below the cloud point, more paraffin wax precipitates from solution. At approximately 3° C. to 5° C. below the cloud point (for fuels that do not contain a pour point depressant additive) the fuel can no longer flow. Solid paraffin wax present in diesel fuel can lead to reduced flow or blockages in filters and component parts of combustion engines.

Diesel fuel comprises a mixture of different hydrocarbon compounds, each with its own freezing point, and does not become solid at a specific temperature, unlike water. As the fuel is cooled, the hydrocarbon components with the highest freezing points solidify first, forming wax crystals. Further cooling causes hydrocarbons with lower freezing points to subsequently solidify. Thus, as the fuel cools, it changes from a homogenous liquid to a liquid containing a few hydrocarbon (wax) crystals, to a mixture of liquid fuel and hydrocarbon crystals, and finally to a near-solid hydrocarbon wax. The pour point of a fuel is defined as the minimum temperature in which the oil has the ability to pour down from a beaker. Diesel formed from fossil fuels typically has a pour point of from −35° C. to −15° C., in which fuels having a lower pour point within this range remain fluid at lower temperatures and therefore are acceptable for use in a wider range of environments.

A further essential property of diesel fuels is the cetane number which defines the ignition quality of the fuel. The cetane number is a measure of how readily the fuel will burn under diesel engine conditions. Higher cetane numbers indicate a more volatile fuel providing a shorter ignition delay period. In general, the cetane number of diesel fuels is between 40 and 55, however in Europe the minimum acceptable cetane number is 51. It has been found that fuels having a higher cetane number provide improved fuel combustion, reduce smoke production and emit lower amounts of NOx and particulates (soot).

It is well understood within this field that the physical properties of a diesel fuel, such as the freezing point, pour point, cetane number and viscosity, and therefore the performance of the fuel in an engine, is linked to both the molecular weight or carbon number and the ratio of different hydrocarbon compounds present. Typically, diesel fuels are primarily composed of paraffin (having a carbon number of C₁₀, C₁₄ C₁₅ and C₂₀), naphthene (having a carbon number of C₁₀, C₁₅ and C₂₀), or aromatic (having a carbon number of, C₁₀, C₁₅ and C₂₀) based hydrocarbons.

However, many previously known methods of producing bio-derived fuels result in a wide variety of hydrocarbon compounds and thus fail to meet the requirements of alternative diesel fuel material, or additional refining steps are required which result in increased time and cost of manufacturing such materials.

The bromine number, or bromine index, is a parameter used to estimate the amount of unsaturated hydrocarbon groups present in the material. Unsaturated hydrocarbon bonds present within a bioderived diesel fuel can be detrimental to the physical properties and performance of the material. Unsaturated carbon bonds can crosslink or react with oxygen to form epoxides. Crosslinking causes the hydrocarbon compounds to polymerise forming gums or varnishes. Gums and varnishes can form deposits within a fuel system or engine, blocking filters and/or tubing supplying fuel to the internal combustion engine. The reduced fuel flow results in a decrease of engine power and can even prevent the engine from starting. Whilst a specific bromine index range is not a standard requirement for diesel fuels, lower bromine index values are clearly beneficial in such materials.

For a bio-derived fuel to be considered a fit for purpose diesel fuel, it must meet the above standardised requirements. However, known methods of producing bio-derived oils typically require further significant and costly refining steps in order to bring the oil to an acceptable specification. Thus, such methods cannot provide an economically competitive alternative to fossil fuels.

Research within this field has previously been focused on indirect methods of forming bio-fuels, comprising, for example i) the fractionation of biomass and fermentation of the cellulosic and hemicellulosic fraction to ethanol, or ii) the destructive gasification of the complete biomass to form syngas before subsequent upgrading to methanol or Fischer-Tropsch methods.

Thermo-conversion methods are currently considered to be the most promising technology in the conversion of biomass to bio-fuels. Thermo-chemical conversion includes the use of pyrolysis, gasification, liquefaction and supercritical fluid extraction. In particular, research has focussed on pyrolysis and gasification for forming bio-fuels.

Gasification comprises the steps of heating biomass materials to temperatures of over 430° C. in the presence of oxygen or air in order to form carbon dioxide and hydrogen (also referred to as synthesis gas or syngas). Syngas can then be converted into liquid fuel using a catalysed Fischer-Tropsch synthesis. The Fischer-Tropsch reaction is usually catalytic and pressurised, operating at between 150 and 300° C. The catalyst used requires clean syngas and so additional steps of syngas cleaning are also required.

A typical gasification method comprising a biomass material produces a H₂:CO ratio of around 1, as shown in Equation 1 below:

C₆H₁₀O₅+H₂O=6CO+6H₂ (Equation 1)

Accordingly, the reaction products are not formed in the ratio of CO to H₂ required for the subsequent Fischer-Tropsch synthesis to form bio-fuels (H₂:CO ratio of ^{˜}2). In order to increase the ratio of H₂ to CO, the following additional steps are commonly applied:
An additional water gas shift reaction is used;
Hydrogen gas is added;
Carbon is extracted using gasification;
increased amounts of CO₂ are produced by using excess steam: C₆H₁₀O₅+7H₂O=6CO₂+12H₂. Carbon dioxide can be converted to carbon monoxide through the addition of carbon, referred to as gasification with carbon dioxide, instead of steam.
Unreacted CO is removed and used for forming of heat and/or power.

Overall, the gasification reaction requires multiple reaction steps and additional reactants, and so the energy efficiency of producing biofuel in this manner is low. Furthermore, the increased time, energy requirements, reactants and catalysts required to combine gasification and Fischer-Tropsch reactions greatly increases manufacturing costs.

Of the thermo-conversion processes, pyrolysis methods are considered to be the most efficient pathway to convert biomass into a bio-derived oil. Pyrolysis methods produce bio-oil, char and non-condensable gases by rapidly heating biomass materials in the absence of oxygen. The ratio of products produced is dependent on the reaction temperature, reaction pressure and the residence time of the pyrolysis vapours formed.

Higher amounts of biochar are formed at lower reaction temperatures and lower heating rates; higher amounts of liquid fuel are formed using lower reaction temperatures, higher heating rates and shorter residence times; and fuel gases are preferentially formed at higher reaction temperatures, lower heating rates and longer residence times. Pyrolysis reactions are split into three main categories, conventional, fast and flash pyrolysis, depending on the reaction conditions used.

In a conventional pyrolysis process the heating rate is kept low (around 5 to 7° C./min) heating the biomass up to temperatures of around 275 to 675° C. with residence times of between 7 and 10 minutes. The slower increase in heating typically results in higher amounts of char being formed compared to bio-oil and gases.

Fast pyrolysis comprises the use of high reaction temperatures (between 575 and 975° C.) and high heating rates (around 300 to 550° C./min) and shorter residence times of the pyrolysis vapour (typically up to 10 seconds) followed by rapid cooling. Fast pyrolysis methods increase the relative amounts of bio-oil formed.

Flash pyrolysis comprises rapid devolitalisation in an inert atmosphere, a high heating rate, high reaction temperatures (typically greater than 775° C.) and very short vapour residence times (<1 second). In order for heat to be sufficiently transferred to the biomass materials in these limited time periods, the biomass materials are required to be present in particulate form with diameters of about 1 mm being common. The reaction products formed are predominantly gas fuel.

However, bio-oils produced through a pyrolysis process often comprise a complex mixture of water and various organic compounds, including acids, alcohols, ketones, aldehydes, phenols, esters, sugars, furans, and hydrocarbons, as well as larger oligomers. The presence of water, acids, aldehydes and oligomers are considered to be responsible for poor fuel properties in the bio-oil formed.

Furthermore, the resulting bio-oil can contain 300 to 400 different oxygenated compounds, which can be corrosive, thermally and chemically unstable and immiscible with petroleum fuels. The presence of these oxygenated compounds also increases the viscosity of the fuels and increase moisture absorption.

In order to address these issues, several upgrading techniques have been proposed, including catalytic (hydro)deoxygenation using hydro-treating catalysts, supported metallic materials, and most recently transition metals. However, catalyst deactivation (via coking) and/or inadequate product yields means that further research is required.

Alternative upgrading techniques include emulsification catalytic hydrogenation, hydrocracking and/or catalytic esterification. However, as previously known methods of producing a bio-derived hydrocarbon feedstock result in a wide range of hydrocarbon compounds, including significant amounts of contaminants and/or undesirable components, the bio-derived hydrocarbon feedstock may not be sufficiently stable to undergo upgrading cracking processes, such as hydrocracking, and can repolymerise blocking or reducing the flow within such reactor systems. Inevitably, the need for additional refinement steps and additional reactant materials increases both the time and cost associated with such processes both in terms of operating costs and capital expenditure.

Due to the poor quality of bio-derived hydrocarbon feedstocks or bio-derived fuels produced using previously known methods, it is often necessary to blend the hydrocarbon feedstock with a fossil fuel or a fraction thereof prior to catalytic cracking techniques or alternatively blending the bio-derived fuel formed with a fossil fuel or fraction thereof in order to the meet the chemical, physical and economic requirements discussed above. In some cases, the weight ratio of the fossil fuel or fraction thereof to the bio-derived hydrocarbon feed/bio-derived fuel can be up to 99.9:0.1 in order to produce a fuel meeting the current standard requirements.

Accordingly, there remains a need in the art for a more concise and efficient method of forming a bio-derived diesel fuel, which can meet at least some of the standardised chemical, physical and performance properties of the fossil fuel-based materials. In particular, it would be desirable to provide a more cost-effective method of producing bio-derived fuels comparable to those produced from fossil fuels.

### DESCRIPTION OF THE INVENTION

In a first embodiment, the present invention relates to a process for forming a bio-diesel fuel from a biomass feedstock, comprising the steps of:
a. providing a biomass feedstock;
b. ensuring the moisture content of the biomass feedstock is 10% or less by weight of the biomass feedstock;
c. pyrolysing the low moisture biomass feedstock at a temperature of at least 950° C. to form a mixture of biochar, hydrocarbon feedstock, non-condensable light gases, such as hydrogen, carbon monoxide, carbon dioxide and methane, and water;
d. separating the hydrocarbon feedstock from the mixture formed in step c.;
e. hydrocracking the hydrocarbon feedstock of step d. in the presence of a hydrocracking catalyst and a hydrogen containing gas to produce a bio-oil; and
f. fractionating the resulting bio-oil to obtain a bio-derived diesel fuel fraction.

Preferably, the biomass feedstock comprises cellulose, hemicellulose or a lignin-based feedstock.

Whilst it is possible to use food crops, such as corn, sugar cane and vegetable oil as a source of biomass, it has been suggested that the use of such starting materials can lead to other environmental and/or humanitarian issues. For example, where food crops are used as a biomass source, more land must be dedicated to growing the additional crops required or a portion of the crops currently grown must be diverted for this use, leading to further deforestation or an increase in the cost of certain foods. Accordingly, in a preferred embodiment of the present invention the biomass feedstock is selected from a non-crop biomass feedstock.

In particular, it has been found that suitable biomass feedstocks may be preferably selected from miscanthus, switchgrass, garden trimmings, straw, such as rice straw or wheat straw, cotton gin trash, municipal solid waste, palm fronds/empty fruit bunches (EFB), palm kernel shells, bagasse, wood, such as hickory, pine bark, Virginia pine, red oak, white oak, spruce, poplar, and cedar, grass hay, mesquite, wood flour, nylon, lint, bamboo, paper, corn stover, or a combination thereof.

During combustion of a hydrocarbon feedstock or a bio-fuel, sulphur contained therein may be oxidised and can further react with water to produce sulphuric acid (H₂SO4). The sulphuric acid formed can condense on the metal surfaces of combustion engines causing corrosion. Thus, further or repeated processing steps are required to reduce the sulphur content of bio-oils to a suitable level. This in turn increases the processing time to produce a viable bio-fuel and increases the cost associated with manufacturing these materials. Accordingly, the biomass feedstock is selected from a low sulphur biomass feedstock. In general, non-crop biomass feedstocks contain low amounts of sulphur, however particularly preferred low sulphur biomass feedstocks include miscanthus, grass, and straw, such as rice straw or wheat straw.

The use of a low sulphur biomass feedstock reduces the extent to which the resulting hydrocarbon feedstock will be required to undergo desulphurisation processing in order to meet industry requirements, in some cases the need for a desulphurisation processing step is eliminated.

During the pyrolysis step, the efficiency of heat transfer through the biomass material has been found to be at least partially dependent on the surface area and volume of the biomass material used. Thus, preferably, the biomass feedstock is ground in order break up the biomass material and/or to reduce its particle size, for example through the use of a tube grinder, a mill, such as a hammer mill, knife mill, slurry milling, or resized through the use of a chipper, to the required particle size. Preferably, the biomass feedstock is provided in the form of pellets, chips, particulates or a powder. More preferably, the pellets, chips, particulates or powders have a diameter of from 5 μm to 10 cm, such as from 5 μm to 25 mm, preferably from 50 μm to 18 mm, more preferably from 100 μm to 10 mm. These sizes have been found to be particularly useful with respect to efficient heat transfer. The diameter of the pellets, chips, particulates and powders defined herein relate to the largest measurable width of the material.

It has also been found that, at high temperatures, such as those required during the high-temperature pyrolysis reaction, the presence of smaller particles can result in an increased chance of dust explosions and fires. However, it has been found that by at least partially removing or preventing the formation of biomass pellets, chips, particles or powders with a diameter of less than about 1 mm, the likelihood of dust explosions or fire occurring is significantly reduced. Accordingly, it is preferable for the biomass feedstock (generally in the form of pellets, chips, particulates or powder) to have a diameter of at least 1 mm, such as from 1 mm to 25 mm, 1 mm to 18 mm or 1 mm to 10 mm. The biomass feedstock may comprise surface moisture. Preferably, such moisture is reduced prior to the step of pyrolysing the biomass feedstock. The amount of moisture present in the biomass feedstock will vary depending on the type of biomass material, transport and storage conditions of the material before use. For example, fresh wood can contain around 50 to 60% moisture. The presence of increased amounts of moisture in the biomass feedstock has been found to reduce the efficiency of the pyrolysis step of the present invention as heat is lost through evaporation of the moisture—rather than heating the biomass material itself, thereby reducing the temperature to which the biomass material is heated or increasing the time to heat the biomass material to the required temperature. This in turn affects the desired ratio of pyrolysis products formed in the hydrocarbon feedstock product.

By way of example, the initial moisture content of the biomass feedstock may be from 10% to 50% by weight of the biomass feedstock, such as from 15% to 45% by weight of the biomass feed stock, or for example from 20% to 30% by weight of the biomass feedstock.

Preferably, the moisture content of the biomass feedstock is reduced to 7% or less by weight, such as 5% or less by weight of the biomass feedstock.

Optionally, the moisture of the biomass feedstock is at least partially reduced before the biomass feedstock is ground.

Alternatively, the biomass feedstock may be formed into pellets, chips, particulates or a powder before the moisture content of the biomass feedstock is at least partially reduced to 10% or less by weight of the biomass feedstock, for example where the forming process is a “wet” process or wherein the removal of at least some moisture from the biomass feedstock may be achieved more efficiently by increasing the surface area of the biomass feedstock material.

The amount of moisture present may be reduced through the use of a vacuum oven, a rotary dryer, a flash dryer or a heat exchanger, such as a continuous belt dryer. Preferably, moisture is reduced through the use of indirect heating methods, such as indirect heat belt dryer, an indirect heat fluidised bed or an indirect heat contact rotary steam-tube dryer.

Indirect heating methods have been found to improve the safety of the overall process as the heat can be transferred in the absence of air or oxygen thereby alleviating and/or reducing the occurrence of fires and/or dust explosions. Furthermore, such indirect heating methods have been found to provide more accurate temperature control which, in turn, allows for better control of the ratio of pyrolysis products formed in the hydrocarbon feedstock product. In preferred processes, the indirect heating method comprises an indirect heat contact rotary steam-tube dryer wherein water vapour is used as a heat carrier medium.

The low moisture biomass feedstock may be pyrolysed at a temperature of at least 1000° C., more preferably at least 1100° C., for example 1120° C., 1150° C., or 1200° C.

In general, the biomass feedstock may be heated by convection heating, microwave heating, electrical heating or supercritical heating. By way of example, the biomass feedstock may be heated through the use of microwave assisted heating, a heating jacket, a solid heat carrier, a tube furnace or an electric heater. Preferably, the heating source is a tube furnace. The tube furnace may be formed from any suitable material, for example a nickel metal alloy.

As noted above, the use of indirect heating of the pyrolysis chamber is preferred as it reduces and/or alleviates the likelihood of dust explosions or fires occurring.

Alternatively or in addition, a heating source is positioned within the pyrolysis reactor in order to directly heat the low moisture biomass feedstock. The heating source may be selected from an electric heating source, such as an electrical spiral heater. It has been found to be beneficial to use two or more electrical spiral heaters within the pyrolysis reactor. The use of multiple heaters can provide a more homogenous distribution of heat throughout the reactor ensuring a more uniform reaction temperature is applied to the low moisture biomass material.

It has been found to be beneficial for the biomass material from step b. to be transported continuously through the pyrolysis reactor. For example, the biomass material may be transported through the pyrolysis reactor using a conveyor, such as a screw conveyor or a rotary belt. Optionally, two or more conveyors can be used to continuously transport the biomass material through the pyrolysis reactor. A screw conveyor has been found to be particularly useful as the speed at which the biomass material is transported through the pyrolysis reactor, and therefore the residence time in the pyrolysis reactor, can be controlled by varying the pitch of the screw conveyor.

Alternatively or in addition, the residence time of the biomass material within the reactor can be varied by altering the width or diameter of the pyrolysis reactor through which the biomass material is conveyed.

The biomass material may be pyrolysed under atmospheric pressure (including essentially atmospheric conditions). Preferably, the biomass material is pyrolysed in an oxygen-depleted environment in order to avoid the formation on unwanted oxygenated compounds, more preferably the biomass material is pyrolysed in an inert atmosphere, for example the reactor is purged with an inert gas, such as nitrogen or argon prior to the pyrolysis step. The biomass material may be pyrolysed under atmospheric pressure (including essentially atmospheric conditions). Alternatively, the biomass material may be pyrolysed under a low pressure, such as from 850 to 1,000 Pa, preferably 900 to 950 Pa. The resulting pyrolysis gases can subsequently be separated by any known methods within this field, for example through condensation and distillation The application of pressure, such as between 850 to 1,000 Pa, during the pyrolysis step and subsequent condensation and distillation of the pyrolysis gases formed has been found to be beneficial in separating the pyrolysis gases from any remaining solids formed during the pyrolysis reaction, such as biochar. Thus, in some embodiments, means are provided for applying the necessary vacuum pressure and/or removing pyrolysis gases formed.

In particular examples, the biomass material is conveyed in a counter-current direction to any pyrolysis gases formed, and any solid material, such as biochar formed as a result of the pyrolysis step is removed separate to the pyrolysis gases formed. As the hot pyrolysis gases pass through the biomass material, heat is transferred from the pyrolysis gases to the biomass material resulting in at least a minor amount of low-temperature pyrolysis of the biomass material.

In addition, the pyrolysis gases are at least partially cleaned as dust and heavy carbons present in the gases are captured by the biomass material.

Where the pyrolysis step is performed under low pressure conditions, a vacuum may be applied so as to aid the flow of pyrolysis gases in a counter-current direction to the biomass material being conveyed through the pyrolysis reactor, and optionally the removal of the pyrolysis gases.

In some examples, the biomass feedstock from step b. is pyrolysed for a period of from 10 seconds to 2 hours, preferably, from 30 seconds to 1 hour, more preferably from 60 second to 30 minutes, such as 100 seconds to 10 minutes.

In accordance with the present invention, step d. may further comprise the step of separating the biochar from the hydrocarbon feedstock product. In some examples, the separation of biochar from the hydrocarbon feedstock product occurs in the pyrolysis reactor. In other examples, the pyrolysis gases formed are first cooled, for example through the use of a venturi, in order to condense the hydrocarbon feedstock product and the biochar is subsequently separated from the liquid hydrocarbon feedstock product and non-condensable gases formed.

The amount of biochar formed in the pyrolysis step may be from 5% to 20% by weight of the biomass feedstock formed in step b., preferably the amount of biochar formed is from 10 to 15% by weight of the biomass feedstock formed in step b.

The hydrocarbon feedstock product may be at least partially separated from the biochar formed using filtration methods (such as the use of a ceramic filter), centrifugation, cyclone or gravity separation.

In accordance with the present invention, step d. may comprise or additionally comprises at least partially separating water from the hydrocarbon feedstock product. It has been found that the water at least partially separated from the hydrocarbon feedstock further comprises organic contaminants, such as pyroligneous acid. Generally, pyroligneous acid is present in the water at least partially separated from the hydrocarbon feedstock product in amounts of from 10% to 30% by weight of the aqueous pyroligneous acid, preferably, pyroligneous acid is present in an amount of from 15% to 28% by weight of the aqueous pyroligneous acid.

Aqueous pyrolignous acid (also referred to as wood vinegar) mainly comprises water but also contains organic compounds such as acetic acid, acetone and methanol. Wood vinegar is known to be used for agricultural purposes such as, as an anti-microbiological agent and a pesticide. In addition, wood vinegar can be used as a fertiliser to improve soil quality and can accelerate the growth of roots, stems, tubers flowers and fruits in plant. Wood vinegar is also known to have medicinal applications, for example in wood vinegar has antibacterial properties, can provide a positive effect on cholesterol, promotes digestion and can help alleviate acid reflux, heartburn and nausea. Thus, there is a further benefit to the present process in being able to isolate such a product stream.

The water may be at least partially separated from the hydrocarbon feedstock by gravity oil separation, centrifugation, cyclone or microbubble separation.

In accordance with the present invention, step d. may comprise or additionally comprises at least partially separating non-condensable light gases from the hydrocarbon feedstock product. The non-condensable light gases may be separated from the hydrocarbon feedstock product through any known methods within this field, for example by means of flash distillation or fractional distillation.

Generally, the non-condensable light gases may be at least partially recycled. Preferably, the non-condensable light gases separated from the hydrocarbon feedstock product are combined with the biomass feedstock being subjected to pyrolysis (step c.).

Where the non-condensable light gases comprise carbon monoxide, carbon monoxide contained therein can be at least partially separated and further processed in a water gas shift (WGS) reaction. In particular, carbon monoxide produced in the pyrolysis step can be combined with steam to produce carbon dioxide and a hydrogen gas fuel. Given that the feedstock used in the WSG reaction is derived from a biomass feedstock, the hydrogen gas produced is a green, bio-derived hydrogen gas. Preferably carbon monoxide is contacted with steam at a temperature of from 205° C. to 482° C. As the WGS reaction is exothermic, carbon monoxide is more preferably contacted with steam at a temperature of from 205° C. to 260° C. in order to increase the yield of bio-derived hydrogen gas.

A shift catalyst may also be present in the WGS reaction, wherein the catalyst may be selected from a copper-zinc-aluminium catalyst or a chromium or copper promoted iron-based catalyst. Preferably the catalyst is selected from a copper-zinc-aluminium catalyst. In order to increase contact between carbon monoxide, steam and the selected shift catalyst, and thus improve the efficiency of the WGS reaction, the catalyst may be contained in a fixed bed or trickle bed reactor.

Bio-derived hydrogen gas produced through the WGS reaction may be at least partly recycled and used in downstream processing steps, such as the hydrocracking step. Alternatively or in addition, the bio-derived hydrogen gas produced can at least partially be used in downstream processing steps such as desulphurisation, deoxygenation and/or hydro-treating steps.

In some embodiments of the present invention, it has been found beneficial to further process the hydrocarbon feedstock product to at least partially remove contaminants contained therein, such as carbon, graphene, polyaromatic compounds and tar. The presence of impurities in the bio-diesel not only significantly affects its engine performance but also complicates its handling and storage. A filter, such as a membrane filter may be used to remove larger contaminants.

In addition or alternatively, fine filtration may be used to remove smaller contaminants which may be suspended in the hydrocarbon feedstock. By way of example, Nutsche filters may be used to remove smaller contaminants.

The step of filtering the hydrocarbon feedstock may be repeated two or more times in order to reduce the contaminants present to a desired level (for example, until the hydrocarbon feedstock is straw coloured).

Alternatively or in addition, contaminants, such as polycyclic aromatic compounds, may be removed by contacting the hydrocarbon feedstock with an active carbon compound and/or a crosslinked organic hydrocarbon resin. The hydrocarbon feedstock may be subsequently separated from the active carbon and/or crosslinked organic resin through any suitable means, such as filtration. In particular, the activated carbon and/or crosslinked organic hydrocarbon resin may be in particulate or pellet form in order to increase contact between the adsorbent and hydrocarbon feedstock, thereby reducing the time required to achieve the desired level of contaminant removal.

However, activated carbon can be costly to regenerate. As an alternative, biochar, for example such as formed in the present process, can be used as a more cost effective and environmentally friendly alternative to activated carbon in order to remove contaminants from the hydrocarbon feed.

As discussed above, crosslinked organic hydrocarbon resins may also be used to remove contaminants from the hydrocarbon feedstock product. In particular, crosslinked organic hydrocarbon resins are useful in removing organic-based contaminants through hydrophobic interaction (i.e. van der Waals) or hydrophilic interaction (hydrogen bonding, for examples with functional groups, such as carbonyl functional groups, present on the surface of the resin material). The hydrophobicity/hydrophilicity of the resin adsorbent material is dependent on the chemical composition and the structure of the resin material selected. Accordingly, the specific adsorbent resin can be tailored to the desired contaminants to be removed. Commonly used crosslinked organic hydrocarbon resins for the removal of contaminants present in biofuels include polysulfone, polyamides, polycarbonates, regenerated cellulose, aromatic polystyrenic or polydivinylbenzene, and aliphatic methacrylate. In particular, aromatic polystyrenic or polydivinylbenzene based resin materials can be used to remove aromatic molecules, such as phenols from the hydrocarbon feed.

In addition, adsorption of contaminant materials can be increased by increasing the surface area and porosity of the crosslinked organic polymer resin, and so in preferred embodiments the hydrocarbon feedstock is contacted with crosslinked organic hydrocarbon porous pellets or particles in order to further improve the purity of the treated hydrocarbon feedstock product and improve the efficiency of the purifying step.

Preferably, tar separated from the hydrocarbon feedstock product is at least partially recycled and combined with the biomass feedstock in step b. It has been found that the tar resulting from the pyrolysis of the biomass materials primarily comprises phenol-based compositions and a range of further oxygenated organic compounds. This pyrolysis tar can be further broken down by use of heat to at least partially form a hydrocarbon feedstock. Accordingly, by at least partially recycling the pyrolysis tar to the biomass feedstock in step b., the percentage yield of hydrocarbon feedstock product obtained from the biomass source can be increased.

The hydrocarbon feedstock product may be contacted with the activated carbon, biochar or crosslinked organic hydrocarbon resin at around atmospheric pressure (including essentially atmospheric conditions).

The activated carbon, biochar and/or crosslinked organic hydrocarbon resin may be contacted for any time necessary to sufficiently remove contaminants present within the hydrocarbon feedstock product. It is considered well within the knowledge of the skilled person within this field to determine a suitable contact times for the hydrocarbon feedstock and adsorbent materials. In some examples, the activated carbon, biochar and/or crosslinked organic hydrocarbon resin is contacted with the hydrocarbon feedstock for at least 15 minutes before separation, preferably at least 20 minutes, more preferably at least 25 minutes.

The step of contacting the hydrocarbon feedstock product with activated carbon, biochar and/or crosslinked organic hydrocarbon resin may be repeated one or more times, in order to reduce the contaminants present to a suitable level (for example, until the hydrocarbon feedstock is straw coloured).

The separated hydrocarbon feedstock formed in step d. preferably comprises at least 0.1% by weight of one or more C₈ compounds, at least 1% by weight of one or more C₁₀ compounds, at least 5% by weight of one or more C₁₂ compounds, at least 5% by weight of one or more C₁₆ compounds and at least 30% by weight of at least one or more C₁₈ compounds.

More preferably, the separated hydrocarbon feedstock formed in step d. comprises at least 0.5% by weight of one or more C₈ compounds, at least 2% by weight of one or more C₁₀ compounds, at least 6% by weight of one or more C₁₂ compounds; at least 6% by weight of one or more C₁₆ compounds and/or at least 33% by weight of one or more C₁₈ compounds.

The separated hydrocarbon feedstock preferably has a pour point of −10° C. or less, preferably −15° C. or less, such as −16° C. or less.

The separated hydrocarbon feedstock preferably comprises 300 ppmw or less, preferably, 150 ppmw or less, more preferably 70 ppmw or less of sulphur.

A second embodiment provides a process for forming a bio-diesel fuel from a bio-derived hydrocarbon feedstock, comprising the steps of:
i. providing a bio-derived hydrocarbon feedstock comprising at least 0.1% by weight of one or more C₈ compounds, at least 1% by weight of one or more C₁₀ compounds, at least 5% by weight of one or more C₁₂ compounds, at least 5% by weight of one or more C₁₆ compounds and at least 30% by weight of at least one or more C₁₈ compounds;
ii. hydrocracking the hydrocarbon feedstock of step i. in the presence of a hydrocracking catalyst and a hydrogen containing gas to produce a bio-oil; and
iii. fractionating the resulting bio-oil to obtain a bio-derived diesel fuel fraction.

Preferably, the bio-derived hydrocarbon feedstock comprises at least 0.5% by weight of one or more C₈ compounds, at least 2% by weight of one or more C₁₀ compounds, at least 6% by weight of one or more C₁₂ compounds; at least 6% by weight of one or more C₁₆ compounds and/or at least 33% by weight of one or more C₁₈ compounds.

The hydrocarbon feedstock of step d. or the hydrocarbon feedstock of step i. can be contacted with the hydrocracking catalyst in an essentially liquid state, an essentially gaseous state or in a partially liquid-partially gaseous state. However, as catalytically cracking reactions can only occur in the gaseous phase, in embodiments where the hydrocarbon feedstock is present in an essentially or partially liquid state, the hydrocarbon feedstock, or part thereof, is preferably vaporised prior to or on contact with the hydrocracking catalyst.

It is understood that the reaction conditions (including the temperature and pressure) of the hydrocracking process can alter the hydrocracking products produced.

Preferably the hydrocarbon feedstock of step d. or the hydrocarbon feedstock of step i. is contacted with the hydrocracking catalyst at a temperature of from 200° C. to 700° C., preferably at a temperature of from 250° C. to 550° C., more preferably a temperature of from 300° C. to 300° C., to produce a bio-oil comprising one or more cracked hydrocarbon products.

In some embodiments, the hydrocarbon feedstock is heated prior to contact with the hydrocracking catalyst, for example the hydrocarbon feedstock may be heated to a temperature of at least 50° C., preferably at least 75° C., more preferably at least 100° C. prior to contact with the hydrocracking catalyst. Preferably, hydrocarbon feedstock may be heated to a temperature of up to 200° C., preferably up 175° C., more preferably up to 150° C. prior to contact with the hydrocracking catalyst. It has been found that where hydrocarbon feedstocks are maintained at a temperature below 50° C. hydrocarbon coking can occur within pipelines or nozzles leading to the hydrocracking catalyst, reducing flow therein or blocking these structures. By maintaining the hydrocarbon feedstock at a temperature of at least 50° C., hydrocarbon coking can be significantly reduced or eliminated.

Preferably, the hydrocarbon feedstock of step d. or the hydrocarbon feedstock of step i. is contacted with the hydrocracking catalyst at a pressure of from 1 MPa to 28 MPa, preferably from 5 MPa to 20 MPa, more preferably from 10 MPa to 17 MPa.

The hydrocarbon feedstock of step d. or the hydrocarbon feedstock of step i. and/or a hydrogen containing gas may be contacted with the hydrocracking catalyst at a liquid hourly space velocity of from 0.1 to 30 hr⁻¹, preferably from 0.2 to 10 hr⁻¹, more preferably from 0.3 to 5 hr⁻¹. As used herein, the term “liquid hourly space velocity” or “LHSV” refers to the numerical ratio of the rate at which the reactants are charged to the hydrocracking reaction zone in barrels per hour at standard conditions of temperature and pressure (SIP) divided by the barrels of catalyst contained in the reaction zone to which the reactants are charged.

The above hydrocracking reaction condition have been found to be particularly useful in efficiently producing hydrocracking products at shorter reaction times.

The hydrocracking step may be performed in any suitable hydrocracking reactor known in this field. For example, the hydrocracking step may be performed in a catalytic reactor, such as a fixed bed reactor, a trickle bed reactor, a fluidised bed reactor or a tubular reactor, such as a coiled tube reactor, a U-tube reactor or a straight tube reactor. The use of a fixed bed reactor, a trickle bed reactor, a fluidised bed reactor or a tubular reactor increases contact between the hydrocarbon feedstock and the hydrocracking catalyst, which in turn increases the efficiency of the hydrocracking step. With regards to the tubular reactors, any suitable tube diameter may be selected with respect to the hydrocracking step defined herein, by way of example, suitable tube diameters may range from 1.5 to 20 cm, preferably from 2 to 10 cm.

In some examples, the hydrocarbon feedstock may pass through a single hydrocracking reactor. In other examples, the hydrocracking reactor may comprise a series of hydrocracking reactors, for example two or more hydrocracking reactors, fluidly connected. Where a series of fluidly connected hydrocracking reactors are used, one or more quenching steps may further be present between the hydrocracking reactors in order to control the temperature of the hydrocracking step. The quenching step may comprise the addition of fresh hydrogen gas at a reduced temperature or recycled hydrocarbon feedstock at a reduced temperature.

The hydrocracking catalyst may in the form of pellets, particulates or a powder. As discussed above, the hydrocracking processes requires that the hydrocarbon feedstock is contacted with the hydrocracking catalyst in a gaseous state. Accordingly, the rate of catalytic cracking of the hydrocarbon feedstock will be, at least partially, dependent on the surface area and volume of the hydrocracking catalyst. Thus, preferably, the hydrocracking catalyst is ground in order to reduce its particle size, for example through the use of a tube grinder, a mill, such as a hammer mill, knife mill, slurry milling, or resized through the use of a chipper, to the required particle size. Preferably, the hydrocracking catalyst is in the form of pellets, particulates or a powder having a diameter of from 0.5 mm to 5 mm, preferably 0.8 mm to 3.5 mm. These particles sizes have been found to be particularly useful for increasing efficiency of the hydrocracking reaction.

In addition or alternatively, the hydrocracking catalyst has a surface area of from 100 m²/g to 800 m²/g, preferably a surface area of from 150 m²/g to 700 m²/g, more preferably from 200 m²/g to 600 m²/g.

The hydrocracking catalyst can be any catalyst known to the skilled person to be suitable for use in a hydrocracking process. Preferably, the hydrocracking catalyst is a bi-functional catalyst comprising one or more metals selected Group VB, Group VIB, Group VIIB and/or Group VIII, of the periodic table, or salts thereof on an acidic support material.

In particular the one or more metals, or salts thereof, may be present on the acidic support material in an amount of from 0.1 to 20 wt % based on the total weight of the hydrocracking catalyst, preferably from 0.1 to 10 wt %, more preferably from 0.5 to 5 wt % based on the total weight of the hydrocracking catalyst. The use of a support has been found to be beneficial as it enables the catalyst to be more homogeneously distributed throughout the hydrocarbon feedstock, increasing the amount of catalyst in contact with the hydrocarbon feedstock and therefore improving the efficiency of the cracking reaction. Accordingly, the use of a supported catalyst can reduce the amount of catalyst required for the hydrocracking process, reducing the overall cost (operating and capex) of the process.

The hydrocracking catalyst may comprise a metal selected from the group consisting of iron, nickel, palladium, platinum, rhodium, iridium, cobalt, tungsten, molybdenum, vanadium, ruthenium, and mixtures thereof, contained on a support material.

The acidic support material can beneficially affect particle strength, cost, porosity, and overall performance of the hydrocracking catalyst. In particular, the acidic support material may be selected from a zeolite, a molecular sieve, silica-alumina, alumina, silica, silica nitride, silica borate, alumina oxide, boron nitride, zirconia, titania, ceria, carbon (such as activated carbon) boria, ferrierite and zirconia-alumina.

In particularly preferred examples, the acidic support material is selected from beta zeolite, Y zeolite, MFI zeolite, ALP0-31, SAP0-11, SAP0-31, SAP0-37, SAP0-41, SM-3, MgAPS0-31, FU-9, NU-10, NU-23, ZSM-12, ZSM-22, ZSM-23, ZSM-35, ZSM-48, ZSM-50, ZSM-57, MeAP0-11, MeAP0-31, MeAP0-41, MeAPS0-11, MeAPS0-31, MeAPS0-41, MeAPS0-46, ELAP0-11, ELAP0-31, ELAP0-41, ELAPS0-11, ELAPS0-31, ELAPS0-41, laumontite, cancrinite, offretite, hydrogen form of stillbite, magnesium or calcium form of mordenite, and magnesium or calcium form of partheite, or combinations thereof.

Alternatively, where a support is not used, the hydrocracking catalyst may be used as a fine powder in the form of one or more sintered metals or a metallic foam wherein the one or more metals are as defined above. Preferably, the metallic fine powder has a particle size of less than about 50 μm, preferably less than about 35 μm, more preferably less than about 25 μm.

Optionally, the hydrocarbon feedstock may be contacted with the hydrocracking catalyst prior to the addition of hydrogen gas. Alternatively, hydrogen gas is contacted with the hydrocracking catalyst prior to contact with the hydrocarbon feedstock. In yet a further example, the hydrocarbon feedstock and hydrogen gas are contacted with the hydrocracking catalyst simultaneously.

The hydrocarbon feedstock may be pre-heated prior to contacting the hydrocracking catalyst and, where present the hydrogen gas. The hydrocarbon feedstock may be pre-heated through the use of a heat exchanger. In particular, the hydrocarbon feedstock may be pre-heated to a temperature of from 150° C. to 650° C., more preferably from 200° C. to 500° C. Alternatively, the hydrocarbon feedstock may be first contacted with the hydrocracking catalyst and, where present the hydrogen gas and subsequently heated to the desired temperature. The hydrocarbon feedstock and hydrogen gas may be heated to the desired temperature using any of the direct or indirect heating methods defined above.

Optionally, the process further comprises at least partially removing hydrogen gas and/or carbon dioxide in the bio-oil formed. The hydrogen gas and/or carbon dioxide can be separated from the bio-oil by any known method in this field, for example through partial vaporisation, such as through the use of a flash separator at around ambient pressure (including essentially atmospheric conditions). The vaporised hydrogen gas and/or carbon dioxide may be subsequently removed via a degassing step. The degassing step may be performed under a vacuum, preferably under a vacuum pressure of less than 6 KPaA, more preferably under a vacuum pressure of less than 5 KPaA, even more preferably under a vacuum pressure of less than 4 KPaA. Alternatively, hydrogen gas and/or carbon dioxide may be removed from the bio-oil via fractional distillation.

Any unreacted hydrogen-rich gas and/or carbon dioxide removed from the bio-oil may be at least partially recycled and combined with the hydrocarbon feedstock of step d. or step i. By at least partially recycling the unreacted hydrogen-gas, the amount of hydrogen gas required to hydrocrack the hydrocarbon feedstock is reduced, and the overall cost (operating and capex) of the process can be reduced.

In accordance with the present invention, the process may further comprise at least partially removing sulphur containing components from the bio-oil formed in step e. or step ii.

In addition or alternatively, the process may further comprise at least partially removing sulphur containing components from the bio-derived diesel fuel fraction formed in step e. or step ii.

The step of at least partially removing sulphur containing components from the bio-oil and/or diesel fuel fraction may comprise at least partially removing one or more of thiols, sulphides, disulphides, alkylated derivatives of thiophene, benzothiophene, dibenzothiophene, 4-methyldibenzothiophene, 4,6-dimethyldibenzothiophene, benzonaphthothiophene and benzo[def]dibenzothiophene present. Preferably, benzothiophene, dibenzothiophene are at least partially removed from the bio-oil and/or diesel fuel fraction.

The step of at least partially removing sulphur containing components from the bio-oil and/or diesel fuel fraction may comprise a hydro-desulphurisation step, preferably a catalytic hydro-desulphurisation step.

The catalyst is preferably selected from nickel molybdenum sulphide (NiMoS), molybdenum, molybdenum disulphide (MoS₂), cobalt/molybdenum such as binary combinations of cobalt and molybdenum, cobalt molybdenum sulphide (CoMoS), Ruthenium disulfide (RuS₂) and/or a nickel/molybdenum-based catalyst. More preferably, the catalyst is selected from a nickel molybdenum sulphide (NiMoS) based catalyst and/or a cobalt molybdenum sulphide (CoMoS) based catalyst.

Alternatively, the catalyst may be selected from any known metal organic framework (MOF) comprising a metal component and an organic ligand, suitable for at least partially removing sulphur containing components from the bio-oil and/or diesel fuel fraction. In particular, the MOF material may be selected from copper-1,3,5-benzenetricarboxylic acid (Cu-BTC) and V/Cu-BTC. Preferably, the catalyst comprises V/Cu-BTC.

The catalyst may be a supported catalyst, wherein the support can be selected from a natural or synthetic material. In particular, the support selected from activated carbon, silica, alumina, silica-alumina, a molecular sieve, and/or a zeolite. The use of a support has been found to be beneficial as it enables the catalyst to be more homogeneously distributed throughout the bio-oil and/or diesel fuel fraction and therefore increases the amount of catalyst in contact with the bio-oil and/or diesel fuel fraction. Accordingly, the use of a supported catalyst can reduce the amount of catalyst required for the hydro-desulphurisation reaction, reducing the overall cost (operating and capex) of the process.

The hydro-desulphurisation step may be performed in a fixed bed or trickle bed reactor to increase contact between the bio-oil and/or diesel fuel fraction and the catalyst present to increase the efficiency of the sulphur removing step.

The hydro-desulphurisation step may be performed at a temperature of from 250° C. to 400° C., preferably from 300° C. and 350° C.

The bio-oil and/or diesel fuel fraction may be pre-heated prior to contacting with the hydrogen gas and, where present the hydro-desulphurisation catalyst. The bio-oil and/or diesel fuel fraction may be pre-heated through the use of a heat exchanger. Alternatively, the bio-oil and/or diesel fuel fraction may be first contacted with the hydrogen gas and, if present, the hydro-desulphurisation catalyst, and subsequently heated to the desired temperature. The bio-oil and/or diesel fuel fraction and hydrogen gas may be heated to the desired temperature using any of the direct or indirect heating methods defined above.

The hydro-desulphurisation step is performed at a reaction pressure of from 4 to 6 MPaG, preferably from 4.5 to 5.5 MPaG, more preferably about 5 MPaG.

During the desulphurisation reaction, sulphur containing components react with hydrogen gas to produce hydrogen sulphide gas (H₂S). The hydrogen sulphide gas formed can be separated from the bio-oil and/or diesel fuel fraction by any known method in this field, for example through the use of a gas separator or the application of a slight vacuum, for example a vacuum pressure of less than 6 KPaA, preferably less than 5 KPaA, more preferably less than 4 KPaA, to the reactor vessel.

Optionally, the reduced sulphur bio-oil and/or diesel fuel fraction may then be cooled, by any suitable means known in the art, for example by use of a heat exchanger, before further processing steps are performed.

Trace amounts of hydrogen sulphide remaining in the reduced sulphur bio-oil and/or reduced sulphur diesel fuel fraction may subsequently be removed through partial vaporisation, for example through the use of a flash separator at around ambient pressure and the vaporised hydrogen sulphide removed through degassing. Preferably, the bio-oil and/or diesel fuel fraction has a temperature of between 60° C. and 120° C., more preferably the bio-oil and/or diesel fuel fraction has a temperature of between 80° C. and 100° C., during the degassing step. The degassing step may be performed under a vacuum, preferably under a vacuum pressure of less than 6 KPaA, more preferably under a vacuum pressure of less than 5 KPaA, even more preferably under a vacuum pressure of less than 4 KPaA.

Any unreacted hydrogen-rich gas removed during the degassing step may be separated from hydrogen sulphide, for example through the use of an amine contactor. The separated gas may then be beneficially recycled and combined with the hydrocarbon feedstock of step d. or step i. By recycling the unreacted hydrogen-gas, the amount of hydrogen gas required to remove sulphur containing components from the bio-oil and/or diesel fuel fraction is reduced, thereby providing a more cost-effective process.

The hydro-desulphurisation step may be repeated one or more times in order to achieve the desired sulphur reduction in the bio-oil and/or diesel fuel fraction. However, typically only one hydro-desulphurisation step is required to sufficiently reduce the sulphur content of the bio-oil and/or diesel fuel fraction to the desired level, especially when the hydrocarbon feedstock is produced in accordance with the methods described herein above.

The desulphurised bio-oil and/or diesel fuel fraction may comprise a sulphur content of less than 5 ppmw, preferably less than 3 ppmw, more preferably less than 1 ppmw.

In some embodiments, the desulphurisation step will not be required. As discussed above, the biomass feedstock may be selected from non-crop biomass feedstocks. Non-crop biomass feedstocks, such as miscanthus, grass, and straw, such as rice straw or wheat straw, contain low amounts of sulphur, and so the hydrocarbon feedstock, bio-oil and diesel fuel fraction resulting therefrom will also comprise lower amounts of sulphur containing components and may inherently meet the limitations stated above. In addition, sulphur containing components present in non-crop biomass feeds predominantly comprise benzothiophene, which is readily decomposed to form benzene and hydrogen sulphide (H₂S) at temperatures of approximately 500° C. Accordingly, such sulphur containing components will decompose during the pyrolysis process defined herein, further reducing the sulphur content of the resulting bio-oil. As a result, the use of such biomass feedstocks can reduce the time and costs associated with the present process.

The process may further comprise the step of hydro-treating the bio-oil formed in step e. or step ii.

The hydro-treating step of the present invention is used to reduce the number of unsaturated hydrocarbon functional groups present in the bio-oil and to beneficially convert the bio-oil to a more stable fuel with a higher energy density.

The hydro-treating step may be performed at a temperature of from 250° C. to 350° C., preferably from 270° C. to 330° C., more preferably from 280° C. to 320° C. Preferably, the bio-oil is heated prior to contact with the hydrogen gas and, where present, the hydro-treating catalyst. The bio-oil may be pre-heated through the use of a heat exchanger. Alternatively, the bio-oil may be first contacted with the hydrogen gas and, if present, the hydrotreating catalyst, and is subsequently heated to the desired temperature. The bio-oil and hydrogen gas may be heated to the desired temperature using any of the direct or indirect heating methods defined above.

The hydro-treating step may be performed at a reaction pressure of from 4 MPaG to 6 MPaG, preferably from 4.5 MPaG to 5.5 MPaG, more preferably about 5M PaG.

In general, the hydro-treating treating step further comprises a catalyst. Preferably, the catalyst comprises a metal catalyst selected from Group IIIB, Group IVB, Group VB, Group VIB, Group VIIB, and Group VIII, of the periodic table. In particular, a metal catalyst selected from Group VIII of the periodic table, for example the catalyst may be selected from Fe, Co, Ni, Ru, Rh, Pd, Os, Ir, and/or Pt, such as a catalyst comprising Ni, Co, Mo, W, Cu, Pd, Ru, Pt. Preferably, the catalyst is selected from a CoMo, NiMo or Ni catalyst.

Where the hydro-treating catalyst is selected from a platinum-based catalyst, it is preferred that the hydro-desulphurisation step is performed prior to the hydro-treating step as sulphur contained with the hydrocarbon feedstock can poison platinum-based catalysts and thus reduce the efficiency of the hydro-treating step.

The catalyst may be a supported catalyst, and the support can be optionally selected from a natural or synthetic material. In particular, the support may be selected from activated carbon, silica, alumina, silica-alumina, a molecular sieve, and/or a zeolite. The use of a support has been found to be beneficial as the catalyst can be more homogeneously distributed throughout bio-oil, increasing the amount of catalyst in contact with the bio-oil. Thus, the use of a supported catalyst can reduce the amount of catalyst required for the hydro-treating reaction, reducing the overall cost (operating and capex) of the process.

The hydro-treating step may be performed in a fixed bed or trickle bed reactor in order to increase the contact between the bio-oil and the catalyst present, thereby improving the efficiency of the hydro-treating reaction.

Optionally, the hydro-treated bio-oil is subsequently cooled, for example by use of a heat exchanger, before any further processing steps are performed.

Prior to fractionating the bio-oil formed, LPG gas may optionally be at least partially separated from the bio-oil by any known method in this field, for example through the use of a gas condenser and/or gas separator. Alternatively or in addition the LPG gas may be separated from the bio-oil by application of a slight vacuum, for example using a vacuum pressure of less than 6 KPaA, preferably less than 5 KPaA, more preferably less than 4 KPaA, to separate LPG from the remaining bio-oil. Alternatively, LPG may be separated from the bio-oil through condensation and flash distillation methods.

The fractionation step of the present invention can separate the refined bio-oil into the respective naphtha, jet fuel and/or heavy diesel fractions. The fractionation method may be performed using any standard methods known in the art, for example through the use of a fractionation column.

The fractionation step may comprise separating a first fractionation cut having a cut point of between 30° C. and 220° C., preferably between 50° C. and 210° C., such as between 70° C. and 200° C. of the refined bio-oil at atmospheric pressure (including essentially atmospheric conditions). Alternatively, the fractionation step may be performed at a pressure of from 850 to 1000 Pa, preferably 900 to 950 Pa. The hydrocarbons in the first fractionation cut may be subsequently cooled and condensed. The first cut fraction is bio-derived gasoline fuel fraction.

The process may further comprise performing a second fractionation cut of the refined bio-oil, with a cut point between 280° C. and 320° C., preferably from 290° C. to 310° C., more preferably about 300° C. The second fractionation cut generally comprises a bio-derived jet fuel. The hydrocarbons in the second fractionation cut may cooled and condensed, for example using a condenser.

The second fractionation cut is a bio-derived jet fuel, preferably am A1 grade jet fuel. Preferably, the physical and chemical properties of the second fractionation cut meet at least some of the standardised requirements of a jet fuel.

The remaining bio-oil in the bottom stream is a bio-derived diesel fuel.

A third embodiment comprises a bio-derived LPG fuel produced in accordance with the process defined herein.

A fourth embodiment comprises a bio-derived gasoline fuel produced in accordance with the process defined herein.

A fifth embodiment comprises a bio-derived jet fuel produced in accordance with the process defined herein.

A sixth embodiment comprises a bio-derived diesel fuel produced in accordance with the process defined herein. Preferably, the bio-derived diesel fuel is formed entirely from a biomass feedstock.

It has been surprisingly found that a bio-derived diesel fuel produced in accordance with the processes of the present inventions meets the criteria of D-2 grade diesel fuel. Preferably, the pour point of the bio-derived diesel fuel is −40° C. or less, preferably −42° C. or less, more preferably −45° C. or less.

The bio-derived diesel fuel may have a cetane number of at least 60, preferably at least 65, more preferably a cetane number of at least 70.

The bio-derived diesel fuel preferably comprises 10 ppmw or less of sulphur, preferably 5 ppmw or less of sulphur, more preferably 1 ppmw or less of sulphur.

Preferably, the bio-derived diesel fuel has no measurable bromine index.

It will be appreciated that although it is technically not essential, the bio-derived diesel fuel of the present invention may be blended with other materials (such a fossil fuel derived fuel materials) in order to meet current fuel standards. By way of example such blending may be up to 50%. However, the surprising quality of the fuel of the present invention makes it feasible for the first time to be able to avoid such processes.

A seventh embodiment provides a system for forming a bio-diesel fuel from a biomass feedstock, wherein the system comprises:
means for ensuring that the moisture content of the biomass feedstock is less than 10% by weight of the biomass feedstock;
a reactor comprising a heating element configured to heat the biomass feedstock to a temperature of at least 950° C. to form a mixture of biochar, hydrocarbon feedstock, non-condensable light gases, such as hydrogen, carbon monoxide, carbon dioxide and methane, and water;
a separator, configured to separate the hydrocarbon feedstock formed from the reaction mixture produced in the reactor;
a hydrocracking reactor suitable for cracking a hydrocarbon feedstock in the presence of a hydrogen gas to produce a bio-oil; and
a separator, configured to separate a diesel fuel fraction from the bio-oil.

In accordance with the present invention, the system may further comprises means for grinding the biomass feedstock before entering the reactor in order to reduce the particle size of the material, for example the biomass feedstock may be formed into pellets, chips, particulates or powders wherein the largest particle diameter is from 1 mm to 25 mm, 1 mm to 18 mm or 1 mm to 10 mm. Preferably, the system comprises a tube grinder, a mill, such as a hammer mill, knife mill, slurry milling, or a chipper, to reduce the particle size of the biomass feedstock.

In some examples, the system may further comprise heating means to reduce the moisture content of the biomass feedstock to less than 10% by weight. The heating means may be selected from a vacuum oven, a rotary dryer, a flash dryer or a heat exchanger, such as a continuous belt dryer. Preferably, the heating means are arranged to indirectly heat the biomass feedstock, for example the heating means may be selected from an indirect heat belt dryer, an indirect heat fluidised bed or an indirect heat contact rotary steam-tube dryer.

In accordance with the present invention, the heating element may be configured to heat the biomass feedstock to a temperature of at least 1000° C., more preferably at least 1100° C., for example 1120° C., 1150° C., or 1200° C.

The heating element may comprise microwave assisted heating, a heating jacket, a solid heat carrier, a tube furnace or an electric heater, preferably the heating element comprises a tube furnace.

Alternatively or in addition, the heating element may be positioned within the reactor and is configured to directly heat the biomass feedstock. By way of example, the heating element may be selected from an electric heating element, such as an electrical spiral heater. Preferably, two or more electrical spiral heaters may be arranged within the reactor.

The biomass feedstock may be transported continuously through the reactor, for example the biomass material may be contained on/within a conveyor, such as screw conveyor or a rotary belt. Optionally, two conveyors may be arranged to continuously transport the biomass material through the reactor.

The reactor may be arranged so that the biomass material is heated under atmospheric pressure. Alternatively, the reactor may be arranged to form low pressure conditions, such as from 850 to 1,000 Pa, preferably 900 to 950 Pa. The reactor may be configured such that the reactor is maintained under vacuum in order to aid the removal of pyrolysis gases formed. Preferably, the reactor is configured to continuously transport the biomass material in a counter-current direction to any pyrolysis gases removed from the reactor using the applied vacuum. In this way, any solid material formed as a result of heating, such as biochar, is removed separate to pyrolysis gases formed.

In accordance with the present invention, the system may further comprise cooling means for condensing pyrolysis gases formed in the reactor in order to produce a hydrocarbon feedstock product and non-condensable light gases.

The system may further comprise means for separating the pyrolysis gas formed, for example through distillation.

The separator may be arranged to separate biochar from the hydrocarbon feedstock product. For example, the separator may comprise filtration means (such as the use of a ceramic filter), centrifugation, or cyclone or gravity separation.

In addition, or alternatively, the separator may comprise means for at least partially separating water from the hydrocarbon feedstock product. For example, the separator may comprise gravity oil separation apparatus, centrifugation, cyclone or microbubble separation means.

In addition or alternatively, the separator may comprise means for at least partially separating non-condensable light gases from the hydrocarbon feedstock product, for example the separator may be arranged such that the hydrocarbon feedstock product undergoes flash distillation or fractional distillation.

The separator may be arranged so as to recycle any non-condensable light gases separated from the hydrocarbon feedstock product to the biomass feedstock prior to entering the reactor.

Alternatively or in addition, where the separator may be arranged to at least partially separate carbon monoxide from the non-condensable gases formed. The system may further comprise means for converting the at least partially separated carbon monoxide to hydrogen gas and carbon dioxide via a water gas shift reaction. In particular, a reactor may be configured to contact the separated carbon monoxide with steam. The reactor further comprises a heating element configured to heat the carbon monoxide and steam to a temperature of from 205° C. to 482° C., more preferably 205° C. to 260° C. In some examples, the reactor comprises a shift catalyst selected from a copper-zinc-aluminium catalyst or a chromium or copper promoted iron-based catalyst. Preferably the catalyst is selected from a copper-zinc-aluminium catalyst.

The separator may be arranged so as to recycle any hydrogen gas formed to the hydrocracking reactor.

In accordance with the present invention, the system may comprise means for further processing the hydrocarbon feedstock product formed. By way of example, the system may be arranged to remove contaminants present in the hydrocarbon feedstock, such as carbon, graphene and tar. Preferably, the system further comprises a filter, such as a membrane filter which can be used to remove larger contaminants present. In addition or alternatively, the system may further comprise fine filtration means, such as Nutsche filters, to remove smaller contaminants suspended in the hydrocarbon feedstock. Alternatively or in addition, the system may be arranged to contact the hydrocarbon feedstock with an active carbon compound and/or a crosslinked organic hydrocarbon resin in order to further process the hydrocarbon feedstock product produced. The activated carbon and/or crosslinked organic hydrocarbon resin may be in particulate or pellet form in order to increase contact between the adsorbent and hydrocarbon feedstock, thereby reducing the time required to achieve the desired level of contaminant removal. The hydrocarbon feedstock product may be contacted with the activated carbon and/or crosslinked organic hydrocarbon resin at around atmospheric pressure (including essentially atmospheric conditions).

In some examples, the system may be arranged so that the hydrocarbon feedstock product is passed through the further processing means two or more times.

The hydrocracking reactor may be configured to heat the hydrocarbon feedstock and hydrogen gas to a temperature of from 200° C. to 700° C., preferably at a temperature of from 250° C. to 550° C., more preferably a temperature of from 300° C. to 300° C., to produce a bio-oil comprising one or more cracked hydrocarbon products.

In addition, the hydrocracking reactor may be arranged to form pressure conditions of from 1 MPa to 28 MPa, preferably from 5 MPa to 20 MPa, more preferably from 10 MPa to 17 MPa.

In addition or alternatively, the hydrocracking reactor may be arranged such that the hydrogen containing gas and/or hydrocarbon feedstock may be contacted with the hydrocracking catalyst at a liquid hourly space velocity of from 0.1 to 30 hr⁻¹, preferably from 0.2 to 10 hr⁻¹, more preferably from 0.3 to 5 hr⁻¹.

In some embodiments, the hydrocracking reactor is selected from a catalytic reactor, such as a fixed bed reactor, a trickle bed reactor, a fluidised bed reactor or a tubular reactor, such as a coiled tube reactor, a U-tube reactor or a straight tube reactor. The hydrocracking catalyst is preferably as defined above. Where the hydrocracking reactor is a tubular reactor, the tube may have a diameter in the range of from 1.5 to 20 cm, preferably from 2 to 10 cm.

In some embodiments, the system may comprise a single hydrocracking reactor, alternatively the system may comprise a series of hydrocracking reactors fluidly connected, such as two or more hydrocracking reactors fluidly connected. In embodiments wherein the system comprises a serious of fluidly connected hydrocracking reactors, the hydrocracking reactors may further comprise means for quenching the temperature of the hydrocarbon feedstock between one or more of the series of fluidly connected hydrocracking reactors. For example, the quenching means may comprise an inlet suitable for introducing fresh hydrogen and or recycled hydrocarbon feedstock having a reduced temperature.

Optionally, the system may be configured to at least partially remove hydrogen gas and/or carbon dioxide in the bio-oil formed. The means for at least partially removing hydrogen gas and/or carbon dioxide can be selected from any known means in this field, by way of example the means for at least partially removing hydrogen gas and/or carbon dioxide may be a flash separator configured to function at around ambient pressure (including essentially atmospheric conditions). In some embodiments the means for at least partially removing hydrogen gas and/or carbon dioxide comprise a vacuum, preferably wherein the vacuum is configured to apply a vacuum pressure of less than 6 KPaA, more preferably a vacuum pressure of less than 5 KPaA, even more preferably a vacuum pressure of less than 4 KPaA. Alternatively, the means for at least partially removing hydrogen gas and/or carbon dioxide may be a fractional distillator.

The system may further comprise means for at least partially removing sulphur containing components from the bio-oil formed or the bio-derived diesel fuel fraction. The means for at least partially removing sulphur containing components from the hydrocarbon feedstock may comprise an inlet for supplying hydrogen gas to the reactor. The reactor may also comprise a hydro-desulphurisation catalyst, preferably a hydro-desulphurisation catalyst as defined above. In some examples, the means for at least partially removing sulphur components from the hydrocarbon feedstock may comprise a heating element arranged to heat the hydrocarbon feedstock to a temperature of from 250° C. to 400° C., preferably from 300° C. and 350° C. Optionally, the heating element may be arranged so as to heat the hydrocarbon feedstock to the required temperature before entering the reactor, by way of example the heating element may be selected from a heat exchanger. Alternatively, the heating element may be arranged so as to heat the hydrocarbon feedstock to the required temperature after contact with the hydrogen gas and, where present, the hydrodesulphurisation catalyst. Where the hydrocarbon feed is heated subsequently to entering the reactor, the heating element may be selected from any of the direct or indirect heating methods defined above. In some examples, the means for least partially removing sulphur containing components from the hydrocarbon feedstock may be maintained under pressure a of from 4 to 6 MPaG, preferably from 4.5 to 5.5 MPaG, more preferably about 5 MPaG.

The reactor may further comprise means for removing hydrogen sulphide gas formed during the desulphurisation process, for example the reactor may further comprise a gas separator arranged to provide a slight vacuum, for example a vacuum pressure of less than 6 KPaA, more preferably a vacuum pressure of less than 5 KPaA, even more preferably a vacuum pressure of less than 4 KPaA, in order to aid the removal hydrogen sulphide gas present.

The system may further comprise cooling means, for example a heat exchanger, in order to cool the reduced sulphur hydrocarbon feedstock before further processing steps are performed.

Optionally, the system may further comprise means for partially vaporising the reduced sulphur hydrocarbon feedstock in order to remove trace amounts of hydrogen sulphide present. By way of example, the partially vaporising means may comprise a flash separator maintained at ambient pressure and a degasser to remove the vaporised hydrogen sulphide. The partially vaporising means may comprise a heating element arranged so as to heat the hydrocarbon feedstock to a temperature of between 60° C. and 120° C., more preferably a temperature of between 80° C. and 100° C., during the degassing step. Optionally, the degasser may be maintained under a vacuum pressure of less than 6 KPaA, more preferably under a vacuum pressure of less than 5 KPaA, even more preferably under a vacuum pressure of less than 4 KPaA.

Preferably, the reactor is configured to recycle any unreacted hydrogen-gas present following the desulphurisation step to the bio-derived hydrocarbon feedstock entering the reactor. In this way, the amount of hydrogen gas required to remove sulphur containing components in the bio-derived hydrocarbon feedstock is reduced, providing a more cost-effective system.

In some examples, the reactor is arranged such that the hydrocarbon feedstock flows through the means for at least partially removing sulphur containing components two or more times.

In addition or alternatively, the system may further comprise means for hydro-treating the bio-oil formed. The means for hydro-treating the hydrocarbon feedstock may comprise a hydro-treating catalyst, for example a hydro-treating catalyst as defined above. The hydro-treating means may further comprise a heating element arranged to heat the hydrocarbon feedstock to a temperature of from 250° C. to 350° C., preferably from 270° C. to 330° C., more preferably from 280° C. to 320° C. Optionally, the heating element may be arranged so as to heat the hydrocarbon feedstock to the required temperature before contacting the means for hydro-treating the hydrocarbon feedstock, by way of example the heating element may be selected from a heat exchanger. Alternatively, the heating element may be arranged so as to heat the hydrocarbon feedstock to the required temperature after contact with the hydrogen gas and, where present, the hydro-treating catalyst. Where the hydrocarbon feed is heated subsequent to contacting the hydro-treating means, the heating element may be selected from any of the direct or indirect heating methods defined above. In some examples, when used to perform a hydro-treating step, the reactor may be maintained under a pressure of from 4 to 6 MPaG, preferably from 4.5 to 5.5 MPaG, more preferably about 5 MPaG.

The system may further comprise cooling means, for example a heat exchanger in order to cool the reduced hydro-treated hydrocarbon feedstock before further processing steps are performed.

Optionally the system may comprise means for at least partially separating LPG gas from the bio-oil. In particular, the system may further comprise degassing means such as a gas condenser and/or gas separator. In some examples, the degassing means are configured to apply a vacuum pressure to the bio-oil. More preferably, the degassing means are configured to apply a vacuum pressure of less than 6 KPaA, more preferably less than 5 KPaA, even more preferably less than 4 KPaA to at least partially remove LPG gases.

The separator may be configured to separate a first fractionation cut having a cut point of between 30° C. and 220° C., preferably between 50° C. and 210° C., such as between 70° C. and 200° C. of the refined bio-oil at atmospheric pressure (i.e. approximately 101.3 KPa). Alternatively, the separator may be arranged such that a first fractionation cut is separated at a pressure of from 850 to 1000 Pa, preferably 900 to 950 Pa.

The separator may further comprise means for cooling the first fractionation cut, for example the cooling means may be selected from a heat-exchanger.

Optionally, the separator may also be configured to separate a second fractionation cut having a cut point between 280° C. and 320° C., preferably from 290° C. to 310° C., more preferably about 300° C. The second fractionation cut generally comprises a bio-derived jet fuel.

The separator may be arranged to collate the remaining bio-oil in the bottom stream is a bio-derived diesel fuel.

In some embodiments, the separator is selected from a fractionation column.

The present inventions as defined herein is illustrated in the accompanying drawings, in which:

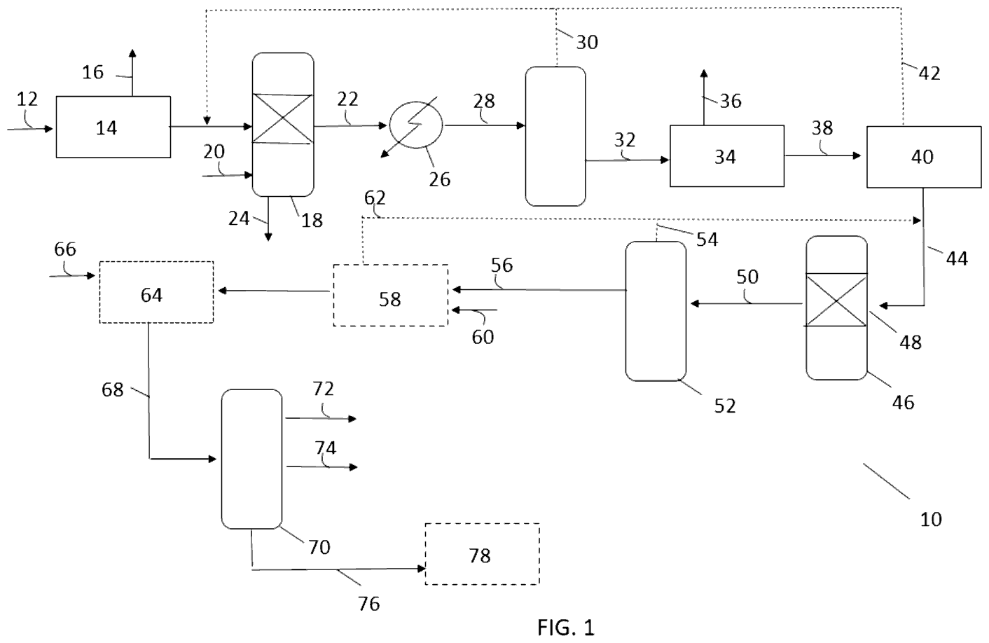

FIG. 1 illustrates a flow diagram of a process of forming a bio-diesel fuel from a biomass feedstock in accordance with the present invention.

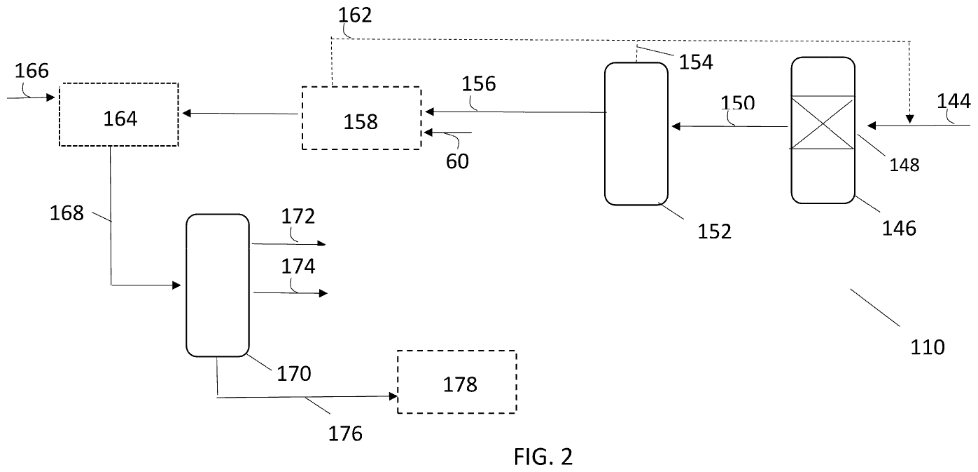

FIG. 2 illustrates a flow diagram of a process of forming a bio-diesel fuel from a bio-derived hydrocarbon feedstock in accordance with the present invention.

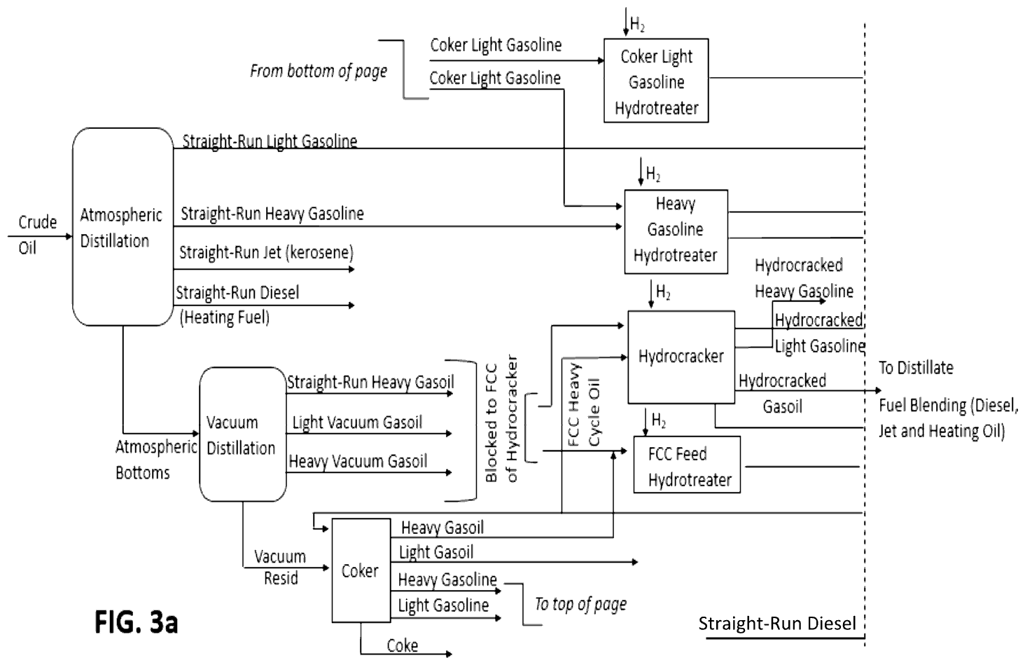

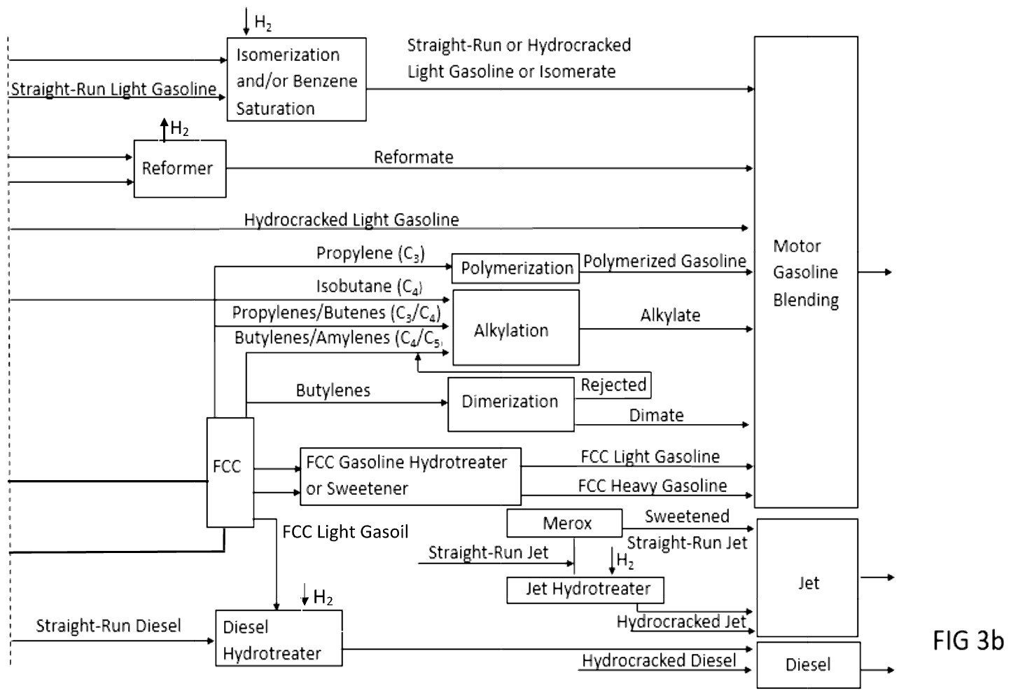

FIG. 3 illustrates a flow diagram of a known method of forming fuels based via a hydrocracking processes.

FIG. 1 illustrates a simplified process (10) of forming a bio-diesel fuel from a biomass feedstock via a hydrocracking reactor. Process steps illustrated in dashed lines are understood to be optional process steps.

A biomass feedstock stream (12) is fed into a feedstock oven or dryer (14) in order to ensure that the moisture content of the biomass feedstock is 10% or less by weight of the biomass feedstock. The feedstock oven or dryer my further comprise an outlet (16) in order to separate any water vapour removed from the biomass material. The low moisture biomass material my then be supplied to a pyrolysis reactor (18), wherein the low moisture biomass material is heated to a temperature of at least 1000° C., more preferably at least 1100° C., for example 1120° C., 1150° C., or 1200° C. The biomass material may be pyrolysed under a low pressure, such as from 850 to 1,000 Pa, preferably 900 to 950 Pa. The pyrolysis reactor further comprises an inlet (20) in order to supply an inert gas, such as nitrogen or argon to the pyrolysis reactor prior to the pyrolysis step being performed. The resulting pyrolysis gases can subsequently be removed from the pyrolysis reactor via an outlet (22). The pyrolysis reactor comprises a further outlet (24) for removing any remaining solids formed during the pyrolysis reaction, such as biochar. The hydrocarbon feedstock product may be at least partially separated from the biochar formed using filtration methods (such as the use of a ceramic filter), centrifugation, cyclone or gravity separation.

The pyrolysis gas extracted from the pyrolysis reactor (22) is transferred to a cooling means (26) in order to condense pyrolysis gases formed to produce a hydrocarbon feedstock product and non-condensable light gases the hydrocarbon feedstock can then be fed into a distillation column (28) wherein the non-condensable light gases are removed from the top of the distillation column (30) and the hydrocarbon feedstock is removed from the bottom of the distillation column (32). The non-condensable light gases (30) separated from the hydrocarbon feedstock product may be at least partially recycled to the low moisture biomass feedstock stream (18). The separated hydrocarbon feedstock (32) is supplied to a separator (34) to at least partially separate water from the hydrocarbon feedstock product (32). For example, the separator may comprise gravity oil separation apparatus, centrifugation, cyclone or microbubble separation means. The separator comprises a first outlet (36) through which water can be removed from the hydrocarbon feedstock and a second outlet (38) through which the reduced water hydrocarbon feedstock can be obtained.

The reduced water hydrocarbon feedstock can be fed into a reactor (40) to at least partially remove contaminants contained therein, such as carbon, graphene, polyaromatic compounds and tar. The reactor may comprise a filter such as a membrane or a Nutsche to remove larger and smaller contaminants, respectively. Alternatively or in addition, an active carbon compound and/or a crosslinked organic hydrocarbon resin to remove contaminants, such as polycyclic aromatic compounds. As an alternative to activated carbon, the reactor may comprise biochar, to remove contaminants from the low moisture hydrocarbon feed. The reactor comprises an outlet (42) in order to separate contaminants from the hydrocarbon feedstock. Where the contaminants separated from the hydrocarbon feedstock comprise tar, the separated tar can be at least partially recycled and combined with the low moisture biomass feedstock stream (18).

The processed hydrocarbon feedstock (44) is then fed into a hydrocracking reactor (46). An example of a hydrocracking system is also illustrated in FIG. 3. FIG. 1 shows that the hydrocracking reactor comprises a hydrocracking catalyst and an inlet (48) for supplying a hydrogen containing gas to the hydrocracking reactor (46). The reactor heats the processed hydrocarbon feedstock (44), hydrocracking catalyst and hydrogen-containing gas (48) to a temperature of from 200° C. to 700° C., preferably at a temperature of from 250° C. to 550° C., more preferably a temperature of from 300° C. to 300° C., to produce a bio-oil comprising one or more cracked hydrocarbon products.

The hydrocracking process may be performed at a pressure of from 1 MPa to 28 MPa, preferably from 5 MPa to 20 MPa, more preferably from 10 MPa to 17 MPa.

In addition or alternatively the hydrogen containing gas and/or hydrocarbon feedstock may be contacted with the hydrocracking catalyst at a liquid hourly space velocity of from 0.1 to 30 hr⁻¹, preferably from 0.2 to 10 hr⁻¹, more preferably from 0.3 to 5 hr⁻¹.

The bio-oil formed (50) may be further processed using a separator (52) such as a flash separator to at least partially remove hydrogen gas and/or carbon dioxide present in the bio-oil. The degassing step may be performed under a vacuum, preferably under a vacuum pressure of less than 6 KPaA, more preferably under a vacuum pressure of less than 5 KPaA, even more preferably under a vacuum pressure of less than 4 KPaA.

The separated hydrogen gas and/or carbon dioxide gas (54) is then at least partially be recycled to the processed hydrocarbon feedstock (44).

The degassed bio-oil (56) is fed into a desulphurisation reactor (58) comprising a hydro-desulphurisation catalyst, wherein the desulphurisation reactor further comprises an inlet (60) to supply a hydrogen-containing gas to the reactor. The desulphurisation reactor heats the bio-oil, hydrogen-containing gas and hydro-desulphurisation catalyst to a temperature of from 250° C. to 400° C., preferably from 300° C. and 350° C.

The desulphurisation step may be performed at a pressure of from 4 to 6 MPaG, preferably from 4.5 to 5.5 MPaG, more preferably about 5 MPaG.

The desulphurisation reactor may further comprise a gas separator to at least partially remove hydrogen sulphide formed from the bio-oil. Optionally, the reduced sulphur bio-oil may then be cooled, by any suitable means known in the art, for example by use of a heat exchanger. Trace amounts of hydrogen sulphide remaining in the reduced sulphur bio-oil may subsequently be at least partially removed through partial vaporisation, for example through the use of a flash separator at around ambient pressure and the vaporised hydrogen sulphide removed through degassing. Preferably, the bio-oil has a temperature of between 60° C. and 120° C., more preferably the bio-oil has a temperature of between 80° C. and 100° C., during the degassing step. The degassing step may be performed under a vacuum, preferably under a vacuum pressure of less than 6 KPaA, more preferably under a vacuum pressure of less than 5 KPaA, even more preferably under a vacuum pressure of less than 4 KPaA.

Any unreacted hydrogen-rich gas (62) removed during the degassing step may be separated from hydrogen sulphide, for example through the use of an amine contactor. The separated gas is then at least partly recycled and combined with the processed hydrocarbon feedstock (44).

The reduced sulphur bio-oil is then fed into a hydro-treating reactor (64) comprising a hydro-treating catalyst to reduce the number of unsaturated hydrocarbon functional groups present in the bio-oil and to beneficially convert the bio-oil to a more stable fuel with a higher energy density.

The hydro-treating reactor further comprises an inlet (66) to supply a hydrogen-containing gas to the reactor. The hydrotreating reactor heats the bio-oil, hydrogen-containing gas and hydro-treating catalyst to a temperature of from 250° C. to 350° C., preferably from 270° C. to 330° C., more preferably from 280° C. to 320° C.

The hydro-treating step may be performed at a reaction pressure of from 4 MPaG to 6 MPaG, preferably from 4.5 MPaG to 5.5 MPaG, more preferably about 5M PaG.

The hydrotreated bio-oil (68) is then transferred to a fractionation column (70), wherein the fractionation column separates a first fractionation cut (72) of the refined bio-oil at a cut point of between 30° C. and 220° C., preferably between 50° C. and 210° C., such as between 70° C. and 200° C. at atmospheric pressure (including essentially atmospheric conditions). In some examples, the separator further comprises cooling means in order to cool and condense the separated first fractionation cut.

The fractionation column forms a second fractionation cut (74) of the refined bio-oil at a cut point of between 280° C. and 320° C., preferably from 290° C. to 310° C., more preferably about 300° C. Again, the separator may further comprise means of cooling and condensing the second fractionation cut, for example a condenser. The second fractionation cut (74) produced is a bio-derived jet-fuel, preferably an A1 grade bio-derived jet fuel. The fractionation column further comprises an outlet (76) for collecting the bottom stream following the second fractionation cut, wherein the bottom stream is a bio-derived diesel fuel.

In addition to reducing the sulphur containing compounds of the bio-oil via the desulphurisation reactor (58) or instead of this desulphurisation step, the bio-derived diesel fuel (76) may be fed into a desulphurisation reactor (78), to at least partly remove sulphur containing components in the bio-fuel. The desulphurisation reactor (78) is as defined above.

FIG. 2 illustrates an alternative simplified process (110) of forming a bio-diesel fuel from a bio-derived hydrocarbon feedstock. Process steps illustrated in dashed lines are understood to be optional process steps.

A bio-derived hydrocarbon feedstock (144) comprising at least 0.1% by weight of one or more C₈ compounds, at least 1% by weight of one or more C₁₀ compounds, at least 5% by weight of one or more C₁₂ compounds, at least 5% by weight of one or more C₁₆ compounds and at least 30% by weight of at least one or more C₁₈ compounds is fed into a hydrocracking reactor (146). An example of a hydrocracking system is also illustrated in FIG. 3. FIG. 2 shows that the hydrocracking reactor comprises a hydrocracking catalyst and in inlet (148) for supplying a hydrogen containing gas to the hydrocracking reactor (146). The reactor heats the bio-derived hydrocarbon feedstock (144), hydrocracking catalyst and hydrogen-containing gas (148) to a temperature of from 200° C. to 700° C., preferably at a temperature of from 250° C. to 550° C., more preferably a temperature of from 300° C. to 300° C., to produce a bio-oil comprising one or more cracked hydrocarbon products.

The hydrocracking process may be performed at a pressure of from 1 MPa to 28 MPa, preferably from 5 MPa to 20 MPa, more preferably from 10 MPa to 17 MPa.

In addition or alternatively the hydrogen containing gas and/or hydrocarbon feedstock may be contacted with the hydrocracking catalyst at a liquid hourly space velocity of from 0.1 to 30 hr⁻¹, preferably from 0.2 to 10 hr⁻¹, more preferably from 0.3 to 5 hr⁻¹.

The bio-oil formed (150) may be further processed using a separator (152) such as a flash separator to at least partially remove hydrogen gas and/or carbon dioxide present in the bio-oil. The degassing step may be performed under a vacuum, preferably under a vacuum pressure of less than 6 KPaA, more preferably under a vacuum pressure of less than 5 KPaA, even more preferably under a vacuum pressure of less than 4 KPaA.

The separated hydrogen gas and/or carbon dioxide gas (154) can then be at least partially recycled to the processed hydrocarbon feedstock (144).

The degassed bio-oil (156) is fed into a desulphurisation reactor (158) comprising a hydro-desulphurisation catalyst, wherein the desulphurisation reactor further comprises an inlet (160) to supply a hydrogen-containing gas to the reactor. The desulphurisation reactor heats the bio-oil, hydrogen-containing gas and hydro-desulphurisation catalyst to a temperature of from 250° C. to 400° C., preferably from 300° C. and 350° C.

The desulphurisation step may be performed at a pressure of from 4 to 6 MPaG, preferably from 4.5 to 5.5 MPaG, more preferably about 5 MPaG.

The desulphurisation reactor may further comprise a gas separator to at least partially remove hydrogen sulphide formed from the bio-oil. Optionally, the reduced sulphur bio-oil may then be cooled, by any suitable means known in the art, for example by use of a heat exchanger. Trace amounts of hydrogen sulphide remaining in the reduced sulphur bio-oil may subsequently be at least partially removed through partial vaporisation, for example through the use of a flash separator at around ambient pressure and the vaporised hydrogen sulphide removed through degassing.

Preferably, the bio-oil has a temperature of between 60° C. and 120° C., more preferably the bio-oil has a temperature of between 80° C. and 100° C., during the degassing step. The degassing step may be performed under a vacuum, preferably under a vacuum pressure of less than 6 KPaA, more preferably under a vacuum pressure of less than 5 KPaA, even more preferably under a vacuum pressure of less than 4 KPaA.

Any unreacted hydrogen-rich gas (162) removed during the degassing step may be separated from hydrogen sulphide, for example through the use of an amine contactor. The separated gas is then at least partly recycled and combined with the processed hydrocarbon feedstock (144).

The reduced sulphur bio-oil is then fed into a hydro-treating reactor (164) comprising a hydro-treating catalyst to reduce the number of unsaturated hydrocarbon functional groups present in the bio-oil and to beneficially convert the bio-oil to a more stable fuel with a higher energy density.

The hydro-treating reactor further comprises an inlet (166) to supply a hydrogen-containing gas to the reactor. The hydrotreating reactor heats the bio-oil, hydrogen-containing gas and hydro-treating catalyst to a temperature of from 250° C. to 350° C., preferably from 270° C. to 330° C., more preferably from 280° C. to 320° C.

The hydro-treating step may be performed at a reaction pressure of from 4 MPaG to 6 MPaG, preferably from 4.5M PaG to 5.5 MPaG, more preferably about 5M PaG.

The hydrotreated bio-oil (168) is then fed into a fractionation column (170), wherein the fractionation column separates a first fractionation cut (172) of the refined bio-oil at a cut point of between 30° C. and 220° C., preferably between 50° C. and 210° C., such as between 70° C. and 200° C. at atmospheric pressure (including essentially atmospheric pressure). In some examples, the separator further comprises cooling means in order to cool and condense the separated first fractionation cut.

The fractionation column forms a second fractionation cut (174) of the refined bio-oil at a cut point of between 280° C. and 320° C., preferably from 290° C. to 310° C., more preferably about 300° C. Again, the separator may further comprise means of cooling and condensing the second fractionation cut, for example a condenser. The second fractionation cut (174) produced is a bio-derived jet-fuel, preferably an A1 grade bio-derived jet fuel. The fractionation column further comprises an outlet (176) for collecting the bottom stream following the second fractionation cut, wherein the bottom stream is a bio-derived diesel fuel.

In addition to reducing the sulphur containing compounds of the bio-oil via the desulphurisation reactor (158) or instead of this desulphurisation step, the bio-derived diesel fuel (176) may be fed into a desulphurisation reactor (178), to at least partly remove sulphur containing components in the bio-fuel. The desulphurisation reactor (178) is as defined above.

1. A process for forming a bio-diesel fuel from a biomass feedstock, comprising the steps of:
a. providing a biomass feedstock;
b. ensuring the moisture content of the biomass feedstock is 10% or less by weight of the biomass feedstock;
c. pyrolysing the low moisture biomass feedstock at a temperature of at least 950° C. to form a mixture of biochar, hydrocarbon feedstock, non-condensable light gases, such as hydrogen, carbon monoxide, carbon dioxide and methane, and water;
d. separating the hydrocarbon feedstock from the mixture formed in step c.;
e. hydrocracking the hydrocarbon feedstock of step d. in the presence of a hydrocracking catalyst and a hydrogen containing gas to produce a bio-oil; and
f. fractionating the resulting bio-oil to obtain a bio-derived diesel fuel fraction.

2. A process according to claim 1, wherein the biomass feedstock comprises cellulose, hemicellulose or lignin-based feedstocks.

3. A process according to claim 1 or claim 2, wherein the biomass feedstock is a non-food crop biomass feedstock, preferably the non-crop biomass feedstock is selected from miscanthus, switchgrass, garden trimmings, straw, such as rice straw or wheat straw, cotton gin trash, municipal solid waste, palm fronds/empty fruit bunches (EFB), palm kernel shells, bagasse, wood, such as hickory, pine bark, Virginia pine, red oak, white oak, spruce, poplar, and cedar, grass hay, mesquite, wood flour, nylon, lint, bamboo, paper, corn stover, or a combination thereof.

4. A process according to any one of claims 1 to 3, wherein the biomass feedstock is in the form of pellets, chips, particulates or a powder, preferably the pellets, chips, particulates or powder have a diameter of from 5 μm to 10 cm, such as from 5 μm to 25 mm, preferably from 50 μm to 18 mm, more preferably from 100 μm to 10 mm.

5. A process according to claim 4, wherein the pellets, chips, particulates or powder have a diameter of at least 1 mm, such as from 1 mm to 25 mm, 1 mm to 18 mm or 1 mm to 10 mm.

6. A process according to any preceding claim, wherein initial moisture content of the biomass feedstock is up to 50% by weight of the biomass feedstock, such as up to 45% by weight of the biomass feed stock, or for example up to 30% by weight of the biomass feedstock.

7. A process according to any preceding claim, wherein the moisture content of the biomass feedstock is reduced to 7% or less by weight, such as 5% or less by weight of the biomass feedstock.

8. A process according to any preceding claim, wherein the step of ensuring the moisture content of the biomass feedstock is 10% or less by weight of the biomass feedstock comprises reducing the moisture content of the biomass feedstock

9. A process according to claim 8 wherein the moisture content of the biomass feedstock is reduced by use of a vacuum oven, a rotary dryer, a flash dryer or a heat exchanger, such as a continuous belt dryer, preferably wherein the moisture content of the biomass feedstock is reduced through the use of indirect heating, for example by using an indirect heat belt dryer, an indirect heat fluidised bed or an indirect heat contact rotary steam-tube dryer.

10. A process according to any preceding claim, wherein the low moisture biomass feedstock is pyrolysed at temperature of at least 1000° C., more preferably at a temperature of at least 1100° C.

11. A process according to any preceding claim, wherein heat is provided to the pyrolysis step by means of convection heating, microwave heating, electrical heating or supercritical heating.

12. A process according to claim 11, wherein the heat source comprises microwave assisted heating, a heating jacket, a solid heat carrier, a tube furnace or an electric heater, preferably the heating source is a tube furnace.

13. A process according to claim 11, wherein the heat source is positioned inside the reactor, preferably the heat source comprises one or more electric spiral heaters, such as a plurality of electric spiral heaters.

14. A process according to any preceding claim, wherein the low moisture biomass is pyrolysed at atmospheric pressure or the low moisture biomass is pyrolysed under a pressure of from 850 to 1000 Pa, preferably from 900 to 950 Pa and, optionally, wherein the pyrolysis gases formed are separated through distillation.

15. A process according to any preceding claim, wherein the low moisture biomass feedstock is pyrolysed for a period of from 10 seconds to 2 hours, preferably, from 30 seconds to 1 hour, more preferably from 60 seconds to 30 minutes, such as 100 seconds to 10 minutes.

16. A process according to any preceding claim, wherein the pyrolysis reactor is arranged such that the low moisture biomass is conveyed in a counter-current direction to any pyrolysis gases formed, and optionally wherein biochar formed as a result of the pyrolysis step leaves pyrolysis reactor separate to the pyrolysis gases.

17. A process according to claim 16, wherein the pyrolysis gases are subsequently cooled, for example through the use of a venturi, to condense the hydrocarbon feedstock product.

18. A process according to any preceding claim, wherein step d. comprises at least partially separating biochar from the hydrocarbon feedstock product, preferably by filtration (such as by use of a ceramic filter), centrifugation, or cyclone or gravity separation and/or
wherein step d. comprises at least partially separating water from the hydrocarbon feedstock product, preferably the water at least partially separated further comprises organic contaminants, more preferably the water at least partially separated from the hydrocarbon feedstock product is a pyroligneous acid, even more preferably wherein the water is at least partially separated from the hydrocarbon feedstock product by gravity oil separation, centrifugation, cyclone or microbubble separation and/or
wherein step d. comprises at least partially separating non-condensable light gases from the hydrocarbon feedstock product, preferably the non-condensable light gases are at least partially separated by use of flash distillation or fractional distillation.

19. A process according to claim 18, wherein the separated non-condensable light gases are recycled and optionally combined with the low moisture biomass feedstock in step c.

20. A process according to claim 18, wherein carbon monoxide present in the non-condensable light gases is contacted with steam in a water gas shift reaction to produce carbon dioxide and a bio-derived hydrogen gas, preferably the water gas shift reaction is performed at a temperature of from 205° C. to 482° C., more preferably a temperature of from 205° C. to 260° C.

21. A process according to claim 20, wherein the water gas shift reaction further comprises a shift catalyst, preferably the shift catalyst is selected from a copper-zinc-aluminium catalyst or a chromium or copper promoted iron-based catalyst, more preferably the shift catalyst is a copper-zinc-aluminium catalyst.

22. A process according to any preceding claim, further comprising the step of filtering the hydrocarbon feedstock product to at least partially remove contaminants, such as carbon, graphene, polyaromatic compounds and/or tar, contained therein, preferably the filtration step comprises the use of a membrane filter to remove larger contaminants and/or fine filtration to remove smaller contaminants, for example by using a Nutsche filter.

23. A process according to claim 22, wherein the filtration step comprises contacting the hydrocarbon feedstock product with an active carbon compound and/or a crosslinked organic hydrocarbon resin and subsequently separating the hydrocarbon feedstock product from the active carbon and/or crosslinked organic hydrocarbon resin compound though filtration.

24. A process according to claim 23, wherein the active carbon compound and/or crosslinked organic hydrocarbon resin is contacted with the hydrocarbon feedstock product under ambient conditions; and/or
wherein the active carbon compound and/or crosslinked organic hydrocarbon resin is contacted with the hydrocarbon feedstock product for at least 15 minutes before separation, preferably at least 20 minutes, more preferably at least 25 minutes; and/or
wherein the step of filtering the hydrocarbon feedstock is performed once or is repeated one or more times.

25. A process according to any one of claims 22 to 24, wherein the tar removed from the hydrocarbon feedstock is recycled and optionally combined with the low moisture biomass feedstock in step c.

26. A process for forming a bio-diesel fuel from a bio-derived hydrocarbon feedstock, comprising the steps of:
i. providing a bio-derived hydrocarbon feedstock comprising at least 0.1% by weight of one or more C₈ compounds, at least 1% by weight of one or more C₁₀ compounds, at least 5% by weight of one or more C₁₂ compounds, at least 5% by weight of one or more C₁₆ compounds and at least 30% by weight of one or more C₁₈ compounds;
ii. hydrocracking the hydrocarbon feedstock of step i. in the presence of a hydrocracking catalyst and a hydrogen containing gas to produce a bio-oil; and
iii. fractionating the resulting bio-oil to obtain a bio-derived diesel fuel fraction.

27. A process according to any preceding claim, wherein the hydrocracking step is performed at a temperature of from 200° C. to 700° C., preferably from 250° C. to 550° C., more preferably from 300° C. to 500° C. and/or under a pressure of from 1 MPa to 28 MPa, preferably from 5 MPa to 20 MPa, more preferably from 10 MPa to 17 MPa.

28. A process according to any preceding claim, wherein the hydrocarbon feedstock of step d. as defined in any one of claims 1 to 25 or the hydrocarbon feedstock of step i. as defined in claim 26 and hydrogen containing gas are contacted with the hydrocracking catalyst at a liquid hourly space velocity of from 0.1 to 30 hr⁻¹, preferably from 0.2 to 10 hr⁻¹, more preferably from 0.3 to 5 hr⁻¹.

29. A process according to any preceding claim, wherein the hydrocracking catalyst is contained in a catalytic reactor, such as a fixed bed reactor, a trickle bed reactor, a fluidised bed reactor or a tubular reactor, such as a coiled tube reactor, a U-tube reactor or a straight tube reactor.

30. A process according to any preceding claim, wherein the hydrocracking catalyst is in the form of pellets, particulates or a powder, preferably the pellets, particulates or powder have a diameter of from 0.5 to 5 mm, preferably from 0.8 to 3.5 mm.

31. A process according to any preceding claim, wherein the hydrocracking catalyst has a surface area of from 100 m²/g to 800 m²/g, preferably a surface area of from 150 m²/g to 700 m²/g, more preferably from 200 m²/g to 600 m²/g.

32. A process according to any preceding claim, wherein the hydrocracking catalyst is a bi-functional catalyst comprising one or more metals selected Group VB, Group VIB, Group VIIB and/or Group VIII, of the periodic table, on an acidic support material.

33. A process according to claim 32, wherein the metal is present in an amount of from 0.1 to 20 wt % based on the total weight of the hydrocracking catalyst, preferably from 0.1 to 10 wt %, more preferably from 0.5 to 5 wt %.

34. A process according to claim 32 or 33, wherein the hydrocracking catalyst comprises a metal selected from the group consisting of iron, nickel, palladium, platinum, rhodium, iridium, cobalt, tungsten, molybdenum, vanadium, ruthenium, and mixtures thereof, contained on a support material.

35. A process according to any one of claims 32 to 34, wherein the acidic support material is selected from a zeolite, a molecular sieve, silica-alumina, alumina, silica, silica nitride, silica borate, alumina oxide, boron nitride, zirconia, titania, ceria, carbon (such as activated carbon) boria, ferrierite and zirconia-alumina, preferably the acidic support material is selected from beta zeolite, Y zeolite, MFI zeolite, ALP0-31, SAP0-11, SAP0-31, SAP0-37, SAP0-41, SM-3, MgAPS0-31, FU-9, NU-10, NU-23, ZSM-12, ZSM-22, ZSM-23, ZSM-35, ZSM-48, ZSM-50, ZSM-57, MeAP0-11, MeAP0-31, MeAP0-41, MeAPS0-11, MeAPS0-31, MeAPS0-41, MeAPS0-46, ELAP0-11, ELAP0-31, ELAP0-41, ELAPS0-11, ELAPS0-31, ELAPS0-41, laumontite, cancrinite, offretite, hydrogen form of stillbite, magnesium or calcium form of mordenite, and magnesium or calcium form of partheite, or combinations thereof.

36. A process according to any preceding claim, wherein the hydrocarbon feedstock of step d. as defined in any one of claims 1 to 25 or the hydrocarbon feedstock of step i as defined in claim 26 and the hydrogen containing gas are contacted with the hydrocracking catalyst simultaneously.

37. A process according to any preceding claim, wherein the hydrocarbon feedstock of step d. as defined in any one of claims 1 to 25 or the hydrocarbon feedstock of step i. as defined in claim 26 is preheated before contacting the hydrocracking catalyst, preferably the hydrocarbon feedstock is pre-heated to a temperature of from 150° C. to 650° C., more preferably from 200° C. to 500° C.

38. A process according to any preceding claim, further comprising the step of at least partially removing hydrogen gas and/or carbon dioxide contained in the bio-oil formed, preferably by use of flash distillation or fractional distillation.

39. A process according to claim 38, wherein the separated hydrogen gas is at least partially recycled to the hydrocracking process step.

40. A process according to any preceding claim, wherein the process further comprises at least partially removing sulphur containing components from the bio-oil formed and/or the bio-derived diesel fuel fraction formed.

41. A process according to claim 40, wherein the sulphur removal step comprises a catalytic hydro-desulphurisation step.

42. A process according to claim 41, wherein the catalyst is part of a fixed bed or a trickle bed reactor.

43. A process according to claim 41 or 42, wherein the catalyst is selected from a nickel molybdenum sulphide (NiMoS), molybdenum, molybdenum disulphide (MoS₂), cobalt/molybdenum, cobalt molybdenum sulphide (CoMoS) and/or a nickel/molybdenum based catalyst, and preferably wherein the catalyst is selected from a nickel molybdenum sulphide (NiMoS) based catalyst, preferably the catalyst is a supported catalyst, such as by means of a support selected from activated carbon, silica, alumina, silica-alumina, a molecular sieve, and/or a zeolite.

44. A process according to any one of claims 40 to 43, wherein the hydro-desulphurisation step is performed at a temperature of from 250° C. to 400° C., preferably from 300° C. and 350° C.; and/or wherein the hydro-desulphurisation step is performed at a reaction pressure of from 4 to 6 MPaG, preferably from 4.5 to 5.5 MPaG, more preferably about 5 MPaG.

45. A process according to any one of claims 40 to 44, wherein the catalytic hydro-desulphurisation process further comprises the step of degassing the reduced sulphur bio-oil and/or diesel fuel fraction to remove hydrogen disulphide gas, such as by cooling the reduced sulphur bio-oil and/or diesel fuel fraction to a temperature of from 60 to 120° C., preferably from 80 to 100° C. and optionally applying a vacuum pressure of less than 6 KPaA, preferably less than 5 KPaA, more preferably less than 4 KPaA.

46. A process according to claim 45, wherein the degassing step removes hydrogen formed during the catalytic hydro-desulphurisation process, and optionally wherein hydrogen removed is recycled to the hydrocracking process step.

47. A process according to any preceding claim, wherein the process further comprises hydro-treating the bio-oil formed.

48. A process according to claim 47, wherein the hydro-treating step is performed at a temperature of from 250° C. to 350° C., preferably from 270° C. to 330° C., more preferably from 280° C. to 320° C.; and/or wherein the hydro-treating step is performed under a pressure of from 4 MPaG to 6M PaG, preferably from 4.5M PaG to 5.5 MPaG.

49. A process according to claim 47 or 48, wherein the hydro-treating process further comprises a catalyst, such as a catalyst as part of a fixed bed or a trickle bed reactor.

50. A process according to claim 49, wherein the catalyst comprises a metal selected from Group IIIB, Group IVB, Group VB, Group VIB, Group VIIB, and Group VIII, of the periodic table, preferably a metal selected from Group VIII of the periodic table, more preferably the catalyst comprises Fe, Co, Ni, Ru, Rh, Pd, Os, Ir, and/or Pt, such as a catalyst comprising Ni, Co, Mo, W, Cu, Pd, Ru, Pt, and preferably wherein the catalyst is selected from CoMo, NiMo or Ni.

51. A process according to claim 49 or 50, wherein the catalyst is a supported catalyst, such as by means of a support selected from activated carbon, silica, alumina, silica-alumina, a molecular sieve, and or a zeolite.

52. A process according to any preceding claim, further comprising the step of at least partially removing LPG from the bio-oil by condensation and/or flash distillation.

53. A process according to claim 52, further comprising the step of applying a vacuum pressure of less than 6 KPaA to the bio-oil, preferably less than 5 KPaA, more preferably less than 4 KPaA, to separate LPG from the remaining bio-oil

54. A process according to any preceding claim, wherein the fractionation step comprises separating a first fractionation cut having a cut point of between 30° C. and 220° C., preferably between 50° C. and 210° C., more preferably between 70° C. and 200° C. of the bio-oil under atmospheric pressure, wherein the separated fraction is collected as a bio-derived gasoline fuel.

55. A process according to claim 54, wherein the process further comprises performing a second fractionation cut having a cut point between 280° C. and 320° C., preferably from 290° C. to 310° C., more preferably about 300° C. of the boil-oil under atmospheric pressure, wherein the separated fraction is collected as a bio-derived jet-fuel.

56. A process according to claim 55, wherein the process comprises collecting the bottom stream of the bio-oil as a bio-derived diesel fuel.

57. A bio-derived LPG fuel formed by a process according to any one of claims 1 to 53 and/or
A bio-derived gasoline fuel formed by a process according to any one of claims 1 to 54 and/or
A bio-derived jet fuel formed by a process according to any one of claims 1 to 55 and/or
A bio-derived diesel fuel formed by a process according to any one of claims 1 to 56, preferably the bio-derived diesel fuel is formed entirely from a biomass feedstock.
